(19) United States
(12) Patent Application Publication
(10) Pub. No.: US 2015/0027873 A1
(43) Pub. Date: Jan. 29, 2015

(54) ITERATIVE REACTIVE DISTILLATION OF DYNAMIC ESTER MIXTURES

(71) Applicant: UNIVERSITY OF HOUSTON SYSTEM, Houston, TX (US)

(72) Inventors: Ognjen Miljanic, Houston, TX (US); Qing Ji, Houston, TX (US)

(73) Assignee: UNIVERSITY OF HOUSTON SYSTEM, Houston, TX (US)

(21) Appl. No.: 14/308,117

(22) Filed: Jun. 18, 2014

Related U.S. Application Data
(60) Provisional application No. 61/836,350, filed on Jun. 18, 2013.

(51) Int. Cl. B01D 3/34

(52) U.S. Cl. CPC B01D 3/34
USPC 203/32

(57) ABSTRACT

An iterative method of performing a reactive distillation of dynamic ester libraries containing n×m (m≦n) components, to reduce such mixtures to n pure ester species. The distillation occurs under anhydrous conditions, using metal alkoxide catalysts. Vacuum distillation of the mixture then isolates the most volatile ester at the expense of other (2n−2) compounds. The volatile ester is removed, and the process repeated with progressively less volatile ester species, yielding high purities and greater than 70% yields.

### CROSS-REFERENCE TO RELATED APPLICATIONS

This U.S. Non Provisional patent application claims priority to U.S. Provisional Application No. 61,836,350 which was filed Jun. 18, 2013, and is hereby incorporated by reference in its entirety.

### STATEMENT REGARDING FEDERALLY SPONSORED RESEARCH OR DEVELOPMENT

This invention was made with government support under Grant No. CHE-1151292 awarded by the National Science Foundation. The United States government has certain rights in the invention.

### BACKGROUND

1. Field of the Disclosure

This disclosure generally relates to iterative reactive distillation of esters. More particularly, the disclosure relates to reducing the complexity of ester mixtures to pure isolated esters products, which are generated in high purities and yields.

2. Background of the Technology

Reactive distillation (RD) is a process in which the chemical reactor doubles as a distillation setup. In eliminating the separate distillation step, RD processes yielded some of chemical industry's most significant savings in energy, construction, and raw material costs during the past three decades. Transesterifications and other reactions with equilibrium constants close to unity are excellent candidates for the application of RD, as the continuous removal of reaction product(s) through distillation allows the reaction to proceed to completion without the need for the large excess of starting materials. Several industrially relevant esters are produced through RD-based esterifications and transesterifications, and RD is also attracting attention in the production of biodiesel through the transesterification of fatty acids. However, known reactive distillations of complex esters produce only a single compound (ester) in a single reactor setup, or use alcohols as feedstocks. Thus, such conventional methods and processes are relatively inefficient, as the production of multiple value-added chemicals requires a series of separate reactive distillation steps.

### BRIEF SUMMARY OF THE DISCLOSED EMBODIMENTS

It is desirable to develop a process whereby multiple value-added ester species may be produced and separated in high yields and high purities in a single reactor, rather than separate reactors, which may yield a faster, cheaper, parallel production of esters and provide large cost savings in the chemical industry. These and other needs in the art are addressed by one embodiment of a method of separating a mixture of compounds, the method comprises reactively distilling the compounds in the presence of a catalyst, wherein the distilling forms: at least a first distillation fraction; and a distillation residue; wherein the first fraction comprises a first volatile product that is at least 70% (w/w), and wherein the residue comprises a non-volatile product that is at least 70% (w/w). In another embodiment the mixture is comprised of greater than two compounds, and in a further embodiment the compounds comprise a dynamic combinatorial library (DCL), in a further still embodiment the compounds of the DCL are structurally related and freely equilibrated.

In embodiments of the method of separating a mixture of compounds (such as dynamic ester libraries), the reactive distillation process utilizes a chemical reactor that doubles as a distillation setup, thereby eliminating the separate distillation step, thus providing a method for continuous removal of volatile product(s) without the need for the large excess of starting materials. In some embodiments, multiple esters are produced and separated in high yields and high purities in such a single reactor. The transesterification reaction thus progresses through a reactive intermediate formed with a metal alkoxide catalyst (M⁺OR⁻). In one embodiment of the method described herein the catalyst comprises a metal selected from: Co, Ga, Ge, Hf, Fe, Ni, Nb, Mo, La, Re, Sc, Si, Ti, Ta, W, Y, Zr, Li; Na; K; Rb; Ti; Al; Ca; Mg; Nb; Cs or any other metal in the periodic table of the elements. In a further embodiment, the catalyst is Ti(OBu)₄, and in a still further embodiment the catalyst is NaOt-Bu. In other embodiments the alkoxide moiety of the catalyst comprises RO—, where R may comprise any substituted, or unsubstituted alkyl or aryl group of any size.

In some embodiments of the method of separating compounds, the compounds are selected from esters, ethers, alkylated and nitrated aromatics, alkenes, alkynes, thiols, disulfides, acetals, hydrazones, and oximes.

In one embodiment of the method of separating compounds, the first volatile product comprises the lowest boiling point of the compounds; and in another embodiment, the non-volatile product comprises the highest boiling point of said compounds. In a further embodiment of the method of separating compounds (such as esters) herein described, distilling forms a second distillation fraction, and in a still further embodiment the second distillation fraction comprises a second volatile product. In another embodiment of the method of separating compound the second volatile product is about 70% (w/w). In one embodiment of the method of separating compound, the distilling forms a third distillation fraction, and in another embodiment, the third distillation fraction comprises a third volatile product, and in a further embodiment the third volatile product is about 70% (w/w).

In one embodiment of the method of separating compounds, the mixtures of compounds comprise hydrolyzed lignin; natural oils; or natural fats; in another embodiment the distillate residue comprises a biomass-derived fuels, in another embodiment, the non-volatile fraction a biomass-derived fuel, and in a further embodiment the fuel is biodiesel or biobutanol.

In a further embodiment, esters may be fragrant compounds, wherein these esters may be derived from either a synthetic process or a naturally occurring material.

### BRIEF DESCRIPTION OF DRAWINGS

For a detailed description of the disclosed exemplary embodiments of the invention, reference will now be made to the accompanying drawings, wherein:

FIG. 1 is a Scheme illustrating how the reactive distillation of a dynamic ester library amplifies the most (first distillate) and the least volatile esters (distillate residue) at the expense of their moderately volatile counterparts, in accordance with an embodiment of this invention;

FIG. 2 is an illustration of the esters and their codes as used throughout, and in accordance with an embodiment of this invention;

FIGS. 3 (a-e) are schematics of the self-sorting of exemplary dynamic [2×2] ester libraries during reactive distillation in accordance with an embodiment of this invention;

FIG. 4 (a-b) are schematics of the self-sorting of exemplary dynamic [3×3] ester libraries during reactive distillation, in accordance with an embodiment of this invention;

FIG. 5 is a schematic a self-sorting of exemplary dynamic [4×4] ester library during reactive distillation, in accordance with an embodiment of this invention; and

FIG. 6 is a schematic a self-sorting of exemplary dynamic and non-stoichiometric [2×3] ester library during reactive distillation in accordance with an embodiment of this invention.

FIG. 7 is the 1H NMR spectra of the starting mixture (bottom) of esters A1, A3, C1, and C3, and the distillate (middle) and distillation residue (top) obtained after the reactive distillation of that mixture, in accordance with an embodiment of this invention;

FIG. 8 is the 1H NMR spectra of the starting mixture (bottom) of esters B1, B3, C1, and C3, and the distillate (middle) and distillation residue (top) obtained after the reactive distillation of that mixture, in accordance with an embodiment of this invention;

FIG. 9 is the 1H NMR spectra of the starting mixture (bottom) of esters A1, A2, B1, and B2, and the distillate (middle) and distillation residue (top) obtained after the reactive distillation of that mixture in accordance with an embodiment of this invention;

FIG. 10 depicts the 1H NMR spectra of the starting mixture (bottom) of esters A1, A4, D1, and D4, and the distillate (middle) and distillation residue (top) obtained after the reactive distillation of that mixture, in accordance with an embodiment of this invention;

FIG. 11 depicts a gas chromatogram of the distillation residue from the reactive distillation of an equimolar mixture of A1, A4, D1, and D4, with internal standard (dodecane) added for calibration (THF was used as the solvent) in accordance with an embodiment of this invention;

FIG. 12 depicts a gas chromatogram of the distillate from the reactive distillation of a mixture of B2, B4, D2, and D4, with internal standard (dodecane) added for calibration. THF was used as the solvent, in accordance with an embodiment of this invention;

FIG. 13 depicts a gas chromatogram of the distillation residue from the reactive distillation of a mixture of B2, B4, D2, and D4, with internal standard (dodecane) added for calibration (THF was used as the solvent) in accordance with an embodiment of this invention;

FIG. 14 depicts the 1H NMR spectra of the starting mixture (bottom) of esters B2, B4, D2, and D4, and the distillate (middle) and distillation residue (top) obtained after the reactive distillation of that mixture in accordance with an embodiment of this invention;

FIG. 15 depicts the 1H NMR spectra of the starting mixture (bottom) of esters A1-C3, and the two distillates (middle) and distillation residue (top) obtained after the reactive distillation of that mixture, in accordance with an embodiment of this invention;

FIG. 16 depicts the 1H NMR spectra of the starting mixture (bottom) of esters A1, A2, A4, B1, B2, B4, D1, D2, and D4, and the two distillates (middle) and distillation residue (top) obtained after the reactive distillation of that mixture in accordance with an embodiment of this invention;

FIG. 17 depicts a Gas chromatogram of the distillation residue from the reactive distillation of an equimolar mixture of A1, A2, A4, B1, B2, B4, D1, D2, and D4, with internal standard (dodecane) added for calibration (THF was used as the solvent) in accordance with an embodiment of this invention;

FIG. 18 depicts the 1H NMR spectra of the three distillates and the distillation residue resulting from the reactive distillation of an equimolar mixture of esters A1, A2, A4, A5, B1, B2, B4, B5, D1, D2, D4, D5, E1, E2, E4, and E5, in accordance with an embodiment of this invention;

FIG. 19 depicts a Gas chromatogram of the second distillate from the reactive distillation of an equimolar mixture of A1, A2, A4, A5, B1, B2, B4, B5, D1, D2, D4, D5, E1, E2, E4, and E5, with internal standard (dodecane) added for calibration (THF was used as the solvent) in accordance with an embodiment of this invention;

FIG. 20 depicts a gas chromatogram of the third distillate from the reactive distillation of an equimolar mixture of A1, A2, A4, A5, B1, B2, B4, B5, D1, D2, D4, D5, E1, E2, E4, and E5, with internal standard (dodecane) added for calibration (THF was used as the solvent) in accordance with an embodiment of this invention;

FIG. 21 depicts a gas chromatogram of the distillation residue from the reactive distillation of an equimolar mixture of A1, A2, A4, A5, B1, B2, B4, B5, D1, D2, D4, D5, E1, E2, E4, and E5, with internal standard (dodecane) added for calibration (THF was used as the solvent) in accordance with an embodiment of this invention;

FIG. 22 depicts a 1H NMR spectra of the starting mixture (bottom) of esters A1, A3, B1, B3, C1 (2 eq.), and C3, and the two distillates (middle) and distillation residue (top) obtained after the reactive distillation of that mixture, in accordance with an embodiment of this invention; and

FIG. 23 depicts ester transmutation experiments performed in accordance with an embodiment of this invention. Organoleptic properties of selected compounds are given next to their structures.

### DETAILED DESCRIPTION OF THE DISCLOSED EMBODIMENTS

The following discussion is directed to various exemplary embodiments of the invention. One skilled in the art will understand that the following description has broad application, and the discussion of any embodiment is meant only to be exemplary of that embodiment, and not intended to intimate that the scope of the disclosure, including the claims, is limited to that embodiment.

The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” The term “substantially” generally means mostly, near completely, or approximately entirely. As used herein, the term “about,” when used in conjunction with a percentage or other numerical amount, means plus or minus 10% of that percentage or other numerical amount. For example, the term “about 80%,” would encompass 80% plus or minus 8%. Further, all publications and other references cited herein are incorporated in their entirety.

This disclosure generally relates to iterative reactive distillation of esters. More particularly, the disclosure relates to reducing the complexity of ester mixtures (n² or n×m components, where m<n) to pure n isolated esters products, which are generated in high purities and yields.

Dynamic Combinatorial Chemistry (DCC) is a tool for the efficient synthesis of libraries of complex structures whose individual properties may be explored through the library's response to the stabilizing influences of external stimuli. A dynamic combinatorial library (DCL) is generated by combining building blocks, functionalized such that they can react with one another either through reversible covalent reactions or specific non-covalent interactions, to form a mixture of interconverting library members.

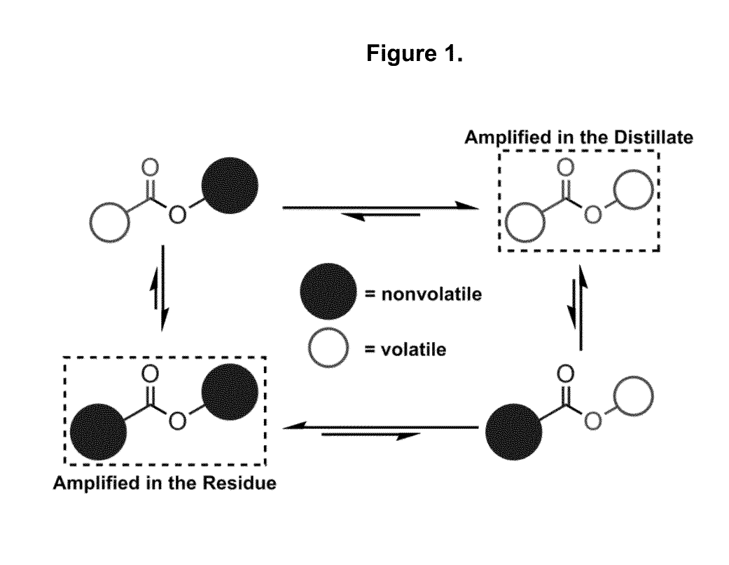

In some embodiments, dynamic combinatorial libraries (DCLs) which comprise mixtures of such freely equilibrating and structurally related compounds, may be reduced in complexity from n×m components (where m≦n) to n components under the iterative influence of irreversible chemicals or physical stimuli, such as irreversible chemical oxidations or reductions, or de facto irreversible physical distillation or precipitation processes. In some embodiments complex ester libraries are prepared by mixing n alcohols with n carboxylic acids and may be simplified under iterative reactive distillation conditions. In further embodiments DCL's may be produced for (but not limited to) compounds that comprise the chemical classification of esters, ethers, alkylated or nitrated aromatics, alkenes, alkynes, thiols, disulfides, acetals, hydrazones, and oximes. In some embodiments, the most volatile ester in the library will be distilled first, forming a first distillation fraction; and a distillation residue; wherein the first fraction thus comprises the first volatile product. As it is removed from equilibrium the remaining mixture will redistribute its remaining members to replenish the removed volatile ester. In some embodiments the process is continued until all of the highly volatile ester is completely removed, thus exhausting the supply in the mixture of the alcoholic and acid components that comprise the most volatile species. The first volatile product is in some embodiments is at least about 70% w/w to about 100% w/w; in other embodiments it is at least 75% w/w, 80% w/w; 85% w/w; 90% w/w, and at least 95% w/w. All of the remaining compounds that are also comprised of either the alcohol or an acid component of the first removed distillate (most volatile ester) are thus destroyed in the process to allow the formation of the most volatile species. In some embodiments, this process simultaneously amplifies the least volatile esters, i.e. increasing the concentration of the compounds in the residual ester mixture that do not comprise the alcohol or carboxylic acid component of the most volatile ester distillate. Thus, the most volatile and the least volatile ester are generated in superior yield at the expense of their precursors of moderate volatility, as illustrated in FIG. 1. In some embodiments therefore, the distillate residue will comprise the least volatile ester (non-volatile product) that is about 70% w/w to about 100% w/w; in other embodiments it is at about 75% w/w, about 80% w/w; about 85% w/w; about 90% w/w, about 95% w/w; and about 98% w/w.

It will be apparent to one of ordinary skill in the art that the process of reactive distillation of such compounds as esters is indeed, an iterative process, whereby the number of discrete distillation fractions obtainable from the n×m (m≦n) ester mixture is in fact n−1 (where 1 represents the distillation residue, which may comprise a discrete product, but is itself not considered a distillation fraction). Hence in some embodiments of the method of separating compounds described herein the first volatile product comprises the lowest boiling point of the compounds, and will form the first distillation fraction, and the distillation residue will comprise the non-volatile product which has the highest boiling point of compounds within the mixture to be separated. In another embodiment, further distilling will form a second distillation fraction, and the second distillation fraction comprises a second volatile product; and in a further embodiment continued distilling may form a third distillation fraction, comprising a third volatile product, and so on until a maximum number of distillation fractions and products are produced in an iterative manner dependent on the number and properties of compounds that comprise the starting library mixture.

Embodiments of the method of separation provided herein, may be applied industrially to complex mixtures of hydrolyzed lignin; natural oils; or natural fats that comprise precursors of biofuels, these example mixtures will also undergo the process of separation as described above, whereby the most volatile ester species will be distilled first, forming a first distillation fraction; and a distillation residue; wherein the first fraction thus comprises the first volatile product. As it is removed from equilibrium the remaining mixture will redistribute its remaining members to replenish the removed volatile ester. In some embodiments the process is continued until all of the highly volatile ester is completely removed, thus exhausting the supply in the mixture of the alcoholic and acid components that comprise the most volatile species. All of the remaining compounds that are also comprised of either the alcohol or an acid component of the first removed distillate (most volatile ester) are thus destroyed in the process to allow the formation of the most volatile species. In some embodiments, this process simultaneously amplifies the least volatile esters, i.e. increasing the concentration of the compounds in the residual ester mixture that do not comprise the alcohol or carboxylic acid component of the most volatile ester distillate. Thus, again the most volatile and the least volatile ester are generated in superior yield at the expense of their precursors of moderate volatility. Hence the resultant distillation residue or the non-volatile component of these examples are useful as a biodiesel or a biobutanol fuel or as aromatic feedstock chemicals.

The following examples of general methods, processing conditions and parameters are given for the purpose of illustrating certain exemplary embodiments of the present invention.

General Methods: All reactions were performed under nitrogen atmosphere in oven-dried glassware. All reagents and solvents were purchased from commercial suppliers and used without further purification, with the exception of esters B1-B3, C2, and C3, which were prepared as described below. NMR spectra were obtained on JEOL ECA-500 spectrometer, with working frequency of 500 MHz for ¹H nuclei and 125 MHz for ¹³C nuclei. ¹H NMR chemical shifts are reported in ppm units relative to the residual signal of the solvent (CDCl₃: 7.25 ppm). All NMR spectra were recorded at 25° C., and ¹³C NMR spectra were recorded with simultaneous decoupling of ¹H nuclei. Compound 1,3,5-trimethoxybenzene (Alfa Aesar, 99%) was utilized as the internal standard for the calculations of yields of different esters on the basis of integration of ¹H NMR spectra of distillates and distillation residues.

Gas chromatography was performed using GC-2010 Shimadzu gas chromatograph. The temperature program that was used for all characterization started with (1) constant temperature of 50° C. for 1 min, followed by (2) monotonous temperature ramping from 50° C. to 270° C. within 4 min, and finally (3) constant temperature of 270° C. for 10 min. Dodecane (Alfa Aesar, 99%) was utilized as an internal standard for the calculation of yields based on the integration of gas chromatograms.

An Example of the Synthesis of an Embodiment of Ester Starting Materials:

Ethyl Butyrate (B1)

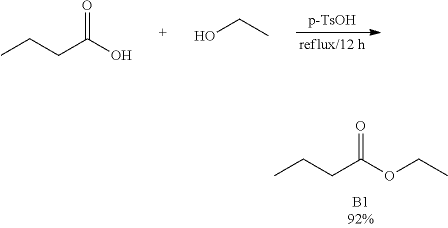

Butyric acid (4.45 g, 4.50 mL, 50.0 mmol), p-toluenesulfonic acid (0.50 g, 2.50 mmol), and EtOH (4.65 g, 6.0 mL, 100 mmol) were placed in a round bottom flask (50 mL). The flask was fitted with a reflux condenser and a Dean-Stark trap with filled with activated 4 Å molecular sieves. The mixture was set to reflux under nitrogen atmosphere. After 12 h, the reaction mixture was diluted with pentane and washed with H₂O (3×50 mL). Removal of pentane by fractional distillation gave ester B1 (5.37 g, 92%) as a colorless liquid. B1: ¹H NMR (CDCl₃): 4.13 (q, ³J=6.8 Hz, 2H), 2.27 (t, ³J=7.4 Hz, 2H), 1.65 (sextet, ³J=7.4 Hz, 2H), 1.26 (t, ³J=6.8 Hz, 3H), 0.96 (t, ³J=7.4 Hz, 3H) ppm. ¹³C NMR (CDCl₃): 173.61, 60.13, 36.32, 18.57, 14.32, 13.70 ppm. Spectral data agree with a previous literature report.¹

Butyl Butyrate (B2)

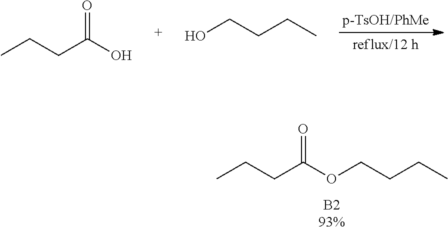

Butyric acid (4.45 g, 4.50 mL, 50.0 mmol) and 1-butanol (3.74 g, 4.60 mL, 50.0 mmol) were mixed with p-toluenesulfonic acid (0.50 g, 2.50 mmol) and PhMe (15 mL) in a 50 mL round bottom flask. A reflux condenser and a Dean-Stark trap filled with 4 Å molecular sieves were attached to the reaction flask and the mixture was heated at reflux for 12 h. After that time, the mixture was diluted with Et₂O (50 mL), and washed with saturated aqueous solutions of NaHCO₃. The aqueous phase was extracted with an additional amount of Et₂O. After washing with brine three times, the ethereal solution was dried over anhydrous MgSO₄. The solvent was removed in vacuo to give B2 (6.71 g, 93%) as a colorless liquid. B2: ¹H NMR (CDCl₃): 4.07 (t, ³J=6.8 Hz, 2H), 2.27 (t, ³J=7.5 Hz, 2H), 1.69-1.40 (m, 6H) 0.9 (t, ³J=6.4 Hz, 6H) ppm. ¹³C NMR (CDCl₃): 173.77, 64.06, 36.26, 30.74, 19.17, 18.50, 13.70, 13.66 ppm. Spectral data agree with a previous literature report.²

Butyl Benzoate (C2)

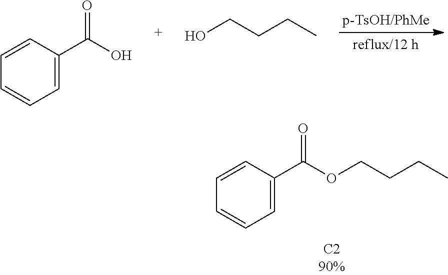

Benzoic acid (6.17 g, 50.0 mmol) and 1-butanol (3.74 g, 4.60 mL, 50.0 mmol) were mixed with p-toluenesulfonic acid (0.50 g, 2.50 mmol) and PhMe (15 mL) in a 50 mL round bottom flask. A reflux condenser and a Dean-Stark trap filled with 4 Å molecular sieves were attached to the reaction flask and the mixture was heated at reflux for 12 h. After that time, the mixture was diluted with Et₂O (50 mL), and washed with saturated aqueous solution of NaHCO₃. The aqueous phase was extracted with an additional amount of Et₂O. After washing with brine three times, the ethereal solution was dried over anhydrous MgSO₄. The solvent was removed in vacuo to give C2 (8.0 g, 90%) as a colorless liquid.

C2: ¹H NMR (CDCl₃): 8.06 (d, ³J=8.7 Hz, 2H), 7.56 (t, ³J=7.2 Hz, 1H), 7.41-7.46 (m, 2H), 4.33 (t, ³J=6.6 Hz, 2H), 1.71-1.81 (m, 2H), 1.43-1.53 (m, 2H), 0.98 (t, ³J=7.5 Hz, 3H) ppm. ¹³C NMR (CDCl₃): 166.61, 132.79, 130.66, 129.58, 128.34, 64.80, 30.88, 19.34, 13.78 ppm. Spectral data agree with a previous literature report.³

Benzyl Butyrate (B3)

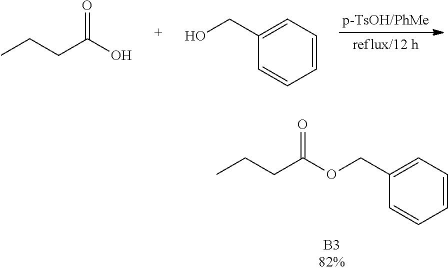

Butyric acid (4.45 g, 4.50 mL, 50.0 mmol), p-toluenesulfonic acid (0.50 g, 2.50 mmol), and PhMe (15 mL) were added to a 50 mL two-neck round bottom flask. The reaction flask was fitted with a reflux condenser and a Dean-Stark trap, and the mixture was set to reflux under nitrogen atmosphere. Benzyl alcohol (5.46 g, 5.20 mL, 50.0 mmol) was added to the reaction flask using a syringe pump, during the course of 6 h. After 12 h, the mixture was diluted with Et₂O (50 mL), and saturated aqueous NaHCO₃ solution was added to remove the catalyst. The aqueous layer was extracted with additional Et₂O, and the combined ethereal solution was washed with brine three times, and dried over MgSO₄. Solvent was removed in vacuo to give B2 (7.33 g, 82%) as a colorless liquid. B3: ¹H NMR (CDCl₃): 7.45-7.35 (m, 5H), 5.13 (s, 2H), 2.35 (t, ³J=7.3 Hz, 2H), 1.68 (sextet, ³J=7.3 Hz, 2H), 0.96 (t, ³J=7.3 Hz, 3H) ppm. ¹³C NMR (CDCl₃): 173.50, 136.32, 128.64, 128.27 (2C), 66.11, 36.26, 18.56, 13.78 ppm. Spectral data agree with a previous literature report.⁴

Benzyl Benzoate (C3)

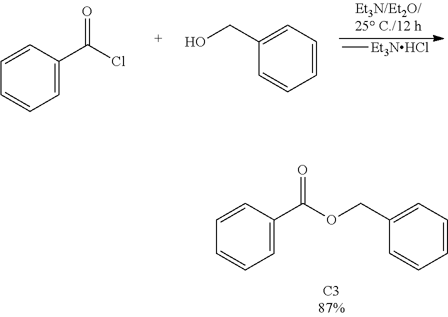

In a 50 mL round bottom flask, benzoyl chloride (7.10 g, 5.90 mL, 50.0 mmol) was dissolved in dry Et₂O (20 mL) under nitrogen atmosphere. A mixture of benzyl alcohol (5.46 g, 5.20 mL, 50.0 mmol) and NEt₃ (6.13 g, 8.20 mL, 60.0 mmol) was slowly added to the Et₂O solution using a syringe pump. After 12 h, the mixture was washed with H₂O (3×50 mL) and dried over MgSO₄. After removal of the solvent, C3 was obtained as a colorless liquid (9.22 g, 87%).

C3: ¹H NMR (CDCl₃): 8.10 (d, ³J=7.0 Hz, 2H), 7.59 (t, ³J=7.5 Hz, 1H), 7.37-7.50 (m, 7H), 5.40 (s, 2H) ppm. ¹³C NMR (CDCl₃): 166.54, 136.26, 133.21, 130.32, 129.89, 128.78, 128.57, 128.43, 128.36, 66.84 ppm. Spectral data agree with a previous literature report.⁵

### EXAMPLES

### Reactive Distillation of [2×2] Ester Libraries

Ethyl Acetate (A1) and Benzyl Benzoate (C3)

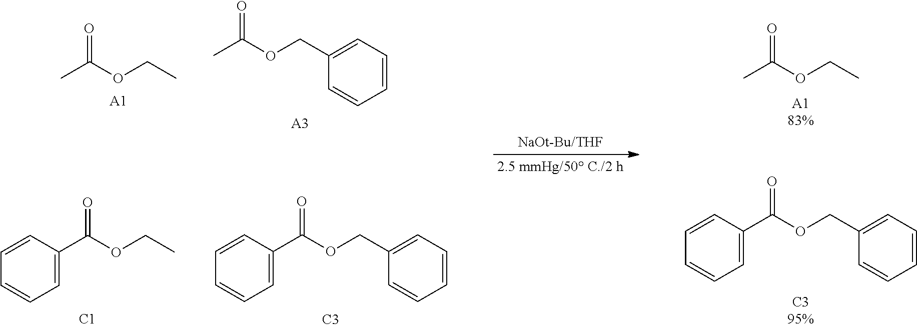

Equimolar amounts of ethyl acetate (A1, 445 mg, 5.00 mmol), ethyl benzoate (C1, 758 mg, 5.00 mmol), benzyl acetate (A3, 758 mg, 5.00 mmol), and benzyl benzoate (C3, 1.07 g, 5.00 mmol) were added to a 25 mL two-neck round bottom flask. The reaction flask was equipped with a short path distillation head that connected it with a receiving flask placed in an i-PrOH/CO₂ ice bath. The mixture was heated up to 50° C. A 1M solution of NaOt-Bu in THF (0.5 mL) was injected into reaction flask in five 0.1 mL portions, with injections separated by 10 min. The distillation setup was placed under vacuum (2.5 mmHg) when the first loading of catalyst was added. After 2 h, the distillate (1.60 g) was collected as a colorless liquid. ¹H NMR spectroscopy confirmed the identity of this liquid as a mixture of A1 (732 mg, 8.31 mmol, 83% yield) and THF (solvent, 720 mg, 9.98 mmol). Esters A3, C1, and C3 could not be observed in the distillate. The residue (2.17 g) was identified by ¹H NMR spectroscopy as a mixture of C3 (2.02 g, 9.51 mmol, 95% yield), A3 (13.5 mg, 0.09 mmol, 5% yield), and C1 (9.91 mg, 0.07 mmol, 4% yield). A1: ¹H NMR (CDCl₃): 4.11 (q, ³J=7.1 Hz, 2H), 2.03 (s, 3H), 1.20 (t, ³J=7.1 Hz, 3H) ppm. ¹³C NMR (CDCl₃): 170.8, 60.1, 20.7, 13.9 ppm. Spectral data agree with a previous literature report.⁶ C3: ¹H NMR (CDCl₃): 8.10 (d, ³J=7.0 Hz, 2H), 7.59 (t, ³J=7.5 Hz, 1H), 7.37-7.50 (m, 7H), 5.40 (s, 2H) ppm. ¹³C NMR (CDCl₃): 166.54, 136.26, 133.21, 130.32, 129.89, 128.78, 128.57, 128.43, 128.36, 66.84 ppm. Spectral data agree with a previous literature report.⁵

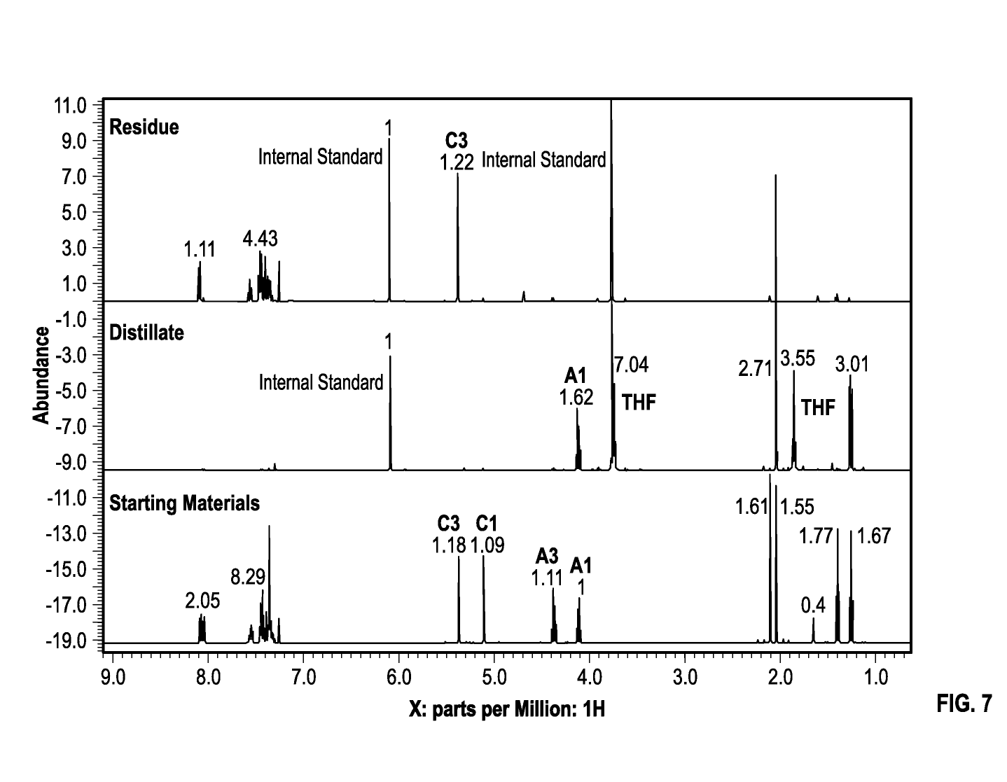

Calculation of the Yields based on the Integration of ¹H NMR Spectra: Internal standard 1,3,5-trimethoxybenzene (123 mg, 0.73 mmol) was added to a 339 mg-aliquot of the distillate. From their relative integrals in the ¹H NMR spectrum (FIG. 7), the number of moles of A1 was calculated as 0.73 mmol×1.62÷(⅔)=1.76 mmol. Thus, the total number of moles of A1 in the distillate was 1.76 mmol×1598 mg÷339 mg=8.31 mmol, corresponding to the yield of A1 of 8.31 mmol÷10.0 mmol×100%=83%. Analogous yield calculation procedure was applied to the distillation residue: 1,3,5-trimethoxybenzene (138 mg, 0.81 mmol) was added to a 339 mg-aliquot of the distillation residue. The number of moles of C3 in the aliquot was calculated to be 0.81 mmol×1.22÷(⅔)=1.48 mmol. The total number of moles of C3 in the whole of distillation residue was 1.48 mmol×2171 mg÷339 mg=9.51 mmol, corresponding to the yield of 9.51 mmol÷10.0 mmol×100%=95%. Yields of intermediate volatility esters A3 and C1 were similarly estimated at 5% and 4%, respectively (FIG. 7). ¹H NMR spectra of the starting mixture (bottom) of esters A1, A3, C1, and C3, and the distillate (middle) and distillation residue (top) obtained after the reactive distillation of that mixture).

Ethyl Butyrate (B1) and Benzyl Benzoate (C3)

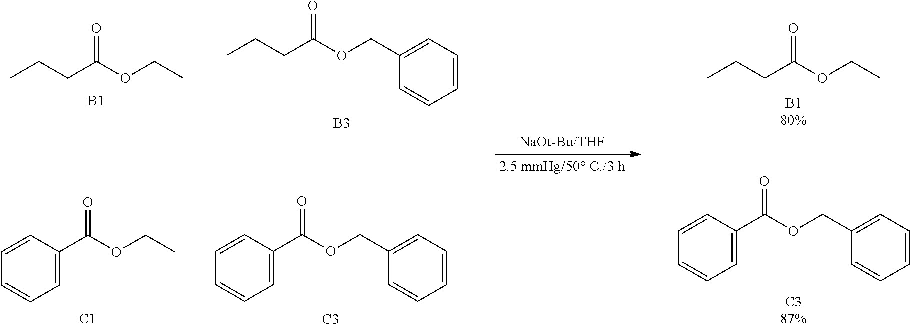

Equimolar amounts of ethyl butyrate (B1, 587 mg, 5.00 mmol), ethyl benzoate (C1, 758 mg, 5.00 mmol), benzyl butyrate (B3, 900 mg, 5.00 mmol), and benzyl benzoate (C3, 1.07 g, 5.00 mmol) were added to a 25 mL two-neck pear-shaped flask. The reaction flask was equipped with a short path distillation head that connected it with a receiving flask placed in an i-PrOH/CO₂ ice bath. The mixture was heated up to 50° C. A 1 M solution of NaOt-Bu in THF (0.5 mL) was injected into reaction flask in five 0.1 mL portions, with injections separated by 10 min. The distillation setup was placed under vacuum (2.5 mmHg) when the first loading of catalyst was added. After 3 h, the distillate (1.98 g) was collected as a colorless liquid. ¹H NMR spectroscopy confirmed the identity of this liquid as a mixture of B1 (935 mg, 8.05 mmol, 80% yield) and THF (solvent, 917 mg, 12.7 mmol). Esters B3, C1, and C3 were not observed in the distillate. The residue (2.35 g) was identified by ¹H NMR spectroscopy as a mixture of C3 (1.84 g, 8.69 mmol, 87% yield), B3 (216 mg, 1.21 mmol, 12% yield), and C1 (118 mg, 0.78 mmol, 8% yield). B1: ¹H NMR (CDCl₃): 4.13 (q, ³J=6.8 Hz, 2H), 2.27 (t, ³J=7.4 Hz, 2H), 1.65 (sextet, ³J=7.4 Hz, 2H), 1.26 (t, ³J=6.8 Hz, 3H), 0.96 (t, ³J=7.4 Hz, 3H) ppm. ¹³C NMR (CDCl₃): 173.61, 60.13, 36.32, 18.57, 14.32, 13.70 ppm. Spectral data agree with a previous literature report.¹C3: ¹H NMR (CDCl₃): 8.10 (d, ³J=7.0 Hz, 2H), 7.59 (t, ³J=7.5 Hz, 1H), 7.37-7.50 (m, 7H), 5.40 (s, 2H) ppm. ¹³C NMR (CDCl₃): 166.54, 136.26, 133.21, 130.32, 129.89, 128.78, 128.57, 128.43, 128.36, 66.84 ppm. Spectral data agree with a previous literature report.⁵

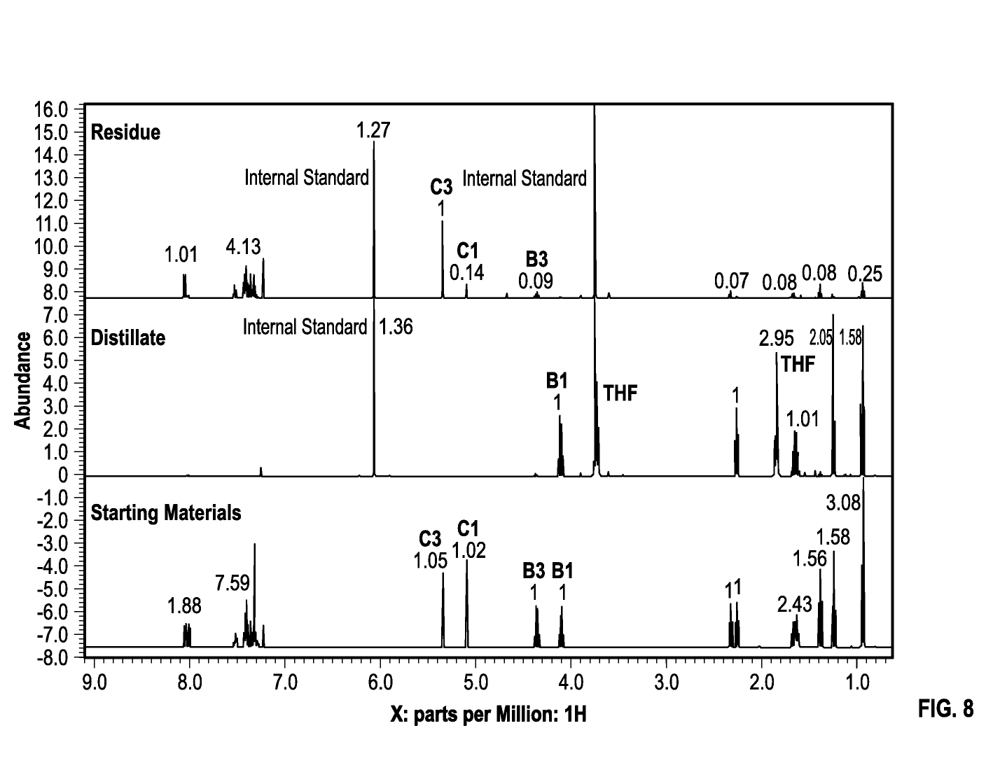

Calculation of the Yields based on the Integration of ¹H NMR Spectra: Internal standard 1,3,5-trimethoxybenzene (156 mg, 0.92 mmol) was added to a 250 mg-aliquot of the distillate. From their relative integrals in the ¹H NMR spectrum (FIG. 8), the number of moles of B1 was calculated as 0.92 mmol÷1.36÷(⅔)=1.01 mmol. Thus, the total number of moles of B1 in the distillate was 1.01 mmol×1984 mg÷250 mg=8.05 mmol, corresponding to the yield of B1 of 8.05 mmol÷10.0 mmol×100%=80%. Analogous yield calculation procedure was applied to the distillation residue: 1,3,5-trimethoxybenzene (147 mg, 0.86 mmol) was added to a 276 mg-aliquot of the residue. The number of moles of C3 in the aliquot was calculated to be 0.86 mmol÷1.27÷(⅔)=1.02 mmol. The total number of moles of C3 in the whole of the distillation residue was 1.02 mmol×2346 mg÷276 mg=8.69 mmol, corresponding to the yield of 8.69 mmol÷10.0 mmol×100%=87%. Yields of intermediate volatility esters B3 and C1 were similarly estimated at 12% and 8%, respectively. FIG. 8. Depicts an ¹H NMR spectra of the starting mixture (bottom) of esters B1, B3, C1, and C3, and the distillate (middle) and distillation residue (top) obtained after the reactive distillation of that mixture.

Ethyl Acetate (A1)) and Butyl Butyrate (B2)

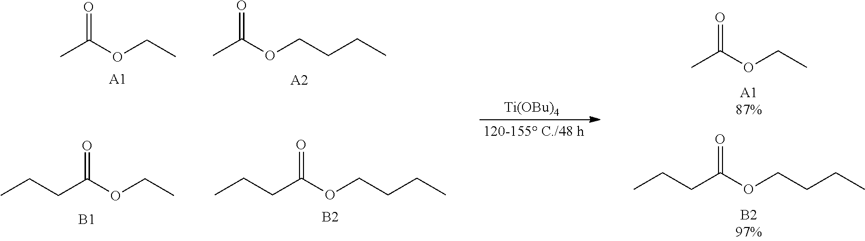

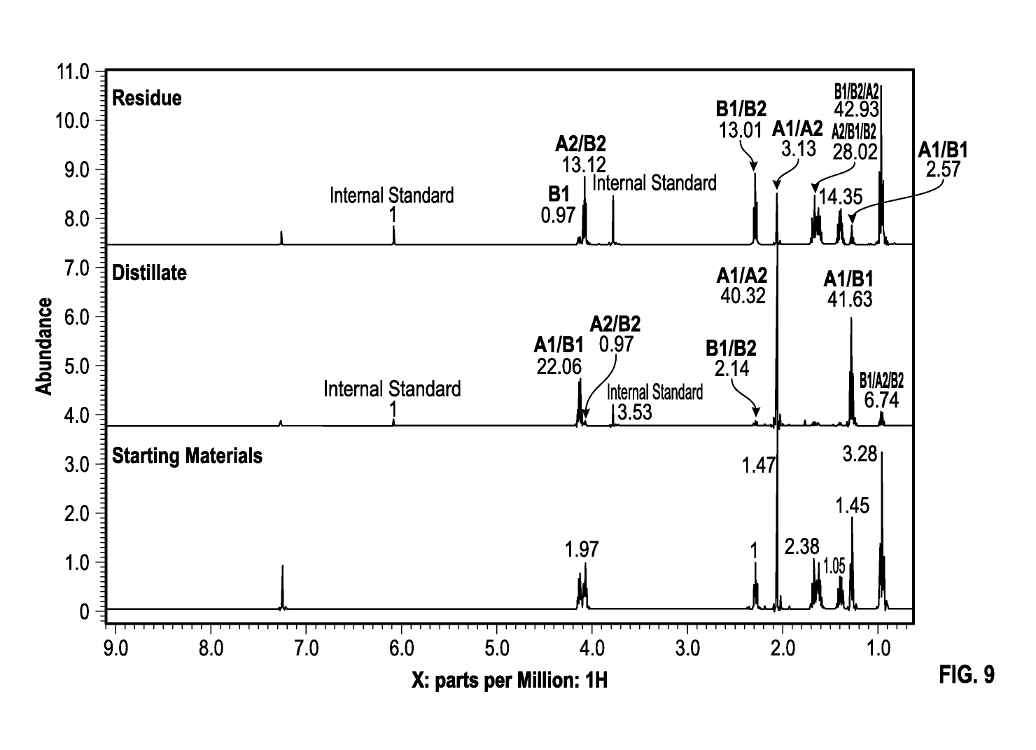

Titanium n-butoxide (413 mg, 1.20 mmol) and an equimolar mixture of A1 (2.67 g, 30.0 mmol), A2 (3.52 g, 30.0 mmol), B1 (3.52 g, 30.0 mmol), and B2 (4.37 g, 30.0 mmol) were placed in a 100 mL round bottom flask. The flask was fitted with a short path distillation head which connected it to a receiving flask that was placed in an i-PrOH/CO₂ ice bath (−78° C.). This mixture was heated from 120 to 155° C. for 48 h. The distillate (4.86 g) was collected as a colorless liquid. ¹H NMR spectroscopy confirmed the identity of this liquid as mostly A1 (4.58 g, 52.1 mmol, 87% yield). The residue (9.40 g) was identified by ¹H NMR spectroscopy as pure B2 (8.41 g, 58.3 mmol, 97% yield). A1: ¹H NMR (CDCl₃): 4.11 (q, ³J=7.1 Hz, 2H), 2.03 (s, 3H), 1.20 (t, ³J=7.1 Hz, 3H) ppm. ¹³C NMR (CDCl₃): 170.8, 60.1, 20.7, 13.9 ppm. Spectral data agree with a previous literature report.⁶ B2: ¹H NMR (CDCl₃): 4.07 (t, ³J=6.8 Hz, 2H), 2.27 (t, ³J=7.5 Hz, 2H), 1.69-1.40 (m, 6H) 0.9 (t, ³J=6.4 Hz, 6H) ppm. ¹³C NMR (CDCl₃): 173.77, 64.06, 36.26, 30.74, 19.17, 18.50, 13.70, 13.66 ppm. Spectral data agree with a previous literature report.² Calculation of the Yields based on the Integration of ¹H NMR Spectra: Internal standard 1,3,5-trimethoxybenzene (39 mg, 0.23 mmol) was added to a 824 mg-aliquot of the distillate. From their relative integrals in the ¹H NMR spectrum (FIG. 9), the number of moles of A1 was calculated to be at least 0.23 mmol×[41.63−(2.14×1.5)]=8.84 mmol. Thus, the total number of moles of A1 in the distillate was 8.50 mmol×4860 mg÷824 mg=52.1 mmol, corresponding to the yield of A1 of 52.1 mmol÷60.0 mmol×100%=87%. Minor fractions were not quantified because of the extensive overlap of their ¹H NMR spectral peaks.

Analogous yield calculation procedure was applied to the distillation residue: 1,3,5-trimethoxybenzene (46 mg, 0.27 mmol) was added to a 755 mg-aliquot of the residue. The number of moles of B2 in the aliquot was calculated to be at least 0.27 mmol×[13.01−(0.97×1.5)]÷(⅔)=4.68 mmol. The total number of moles of B2 in the whole of the distillation residue was 4.68 mmol×9400 mg÷755 mg=58.3 mmol, corresponding to the yield of 58.3 mmol÷60.0 mmol×100%=97%. Minor fractions were not quantified because of the extensive overlap of their ¹H NMR spectral peaks. FIG. 9. ¹H NMR spectra of the starting mixture (bottom) of esters A1, A2, B1, and B2, and the distillate (middle) and distillation residue (top) obtained after the reactive distillation of that mixture.

Ethyl Acetate (A1)) and Octyl Octanoate (D4)

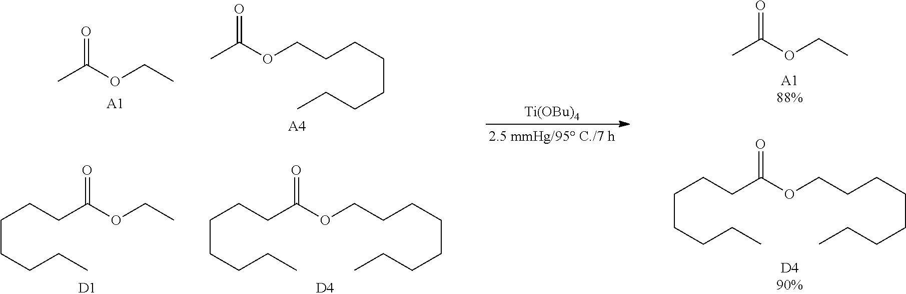

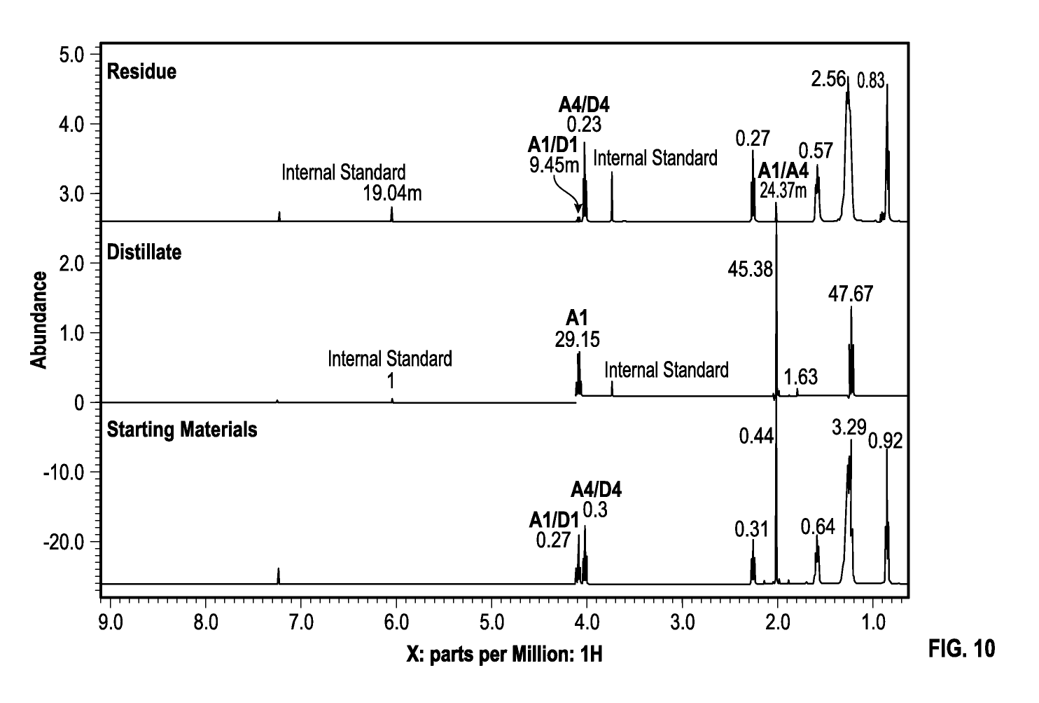

Titanium n-butoxide (138 mg, 0.40 mmol) and an equimolar mixture of A1 (0.89 g, 10.0 mmol), A4 (1.74 g, 10.0 mmol), D1 (1.74 g, 10.0 mmol), and D4 (2.59 g, 10.0 mmol) were placed into a 100 mL round bottom flask. The reaction flask was equipped with a 185 mm-long Vigreux column that was cooled by an i-PrOH/CO₂ cold trap (−30° C.). Short path distillation head was used to connect the top of the Vigreux column with a receiving flask which was placed into a separate i-PrOH/CO₂ ice bath (−78° C.). This reaction mixture was heated at 95° C. for 7 h under vacuum (2.5 mm Hg). The distillate (1.56 g) was collected as a colorless liquid. ¹H NMR spectroscopy confirmed the identity of this liquid as A1 (1.55 g, 17.6 mmol, 88% yield). Other three esters—A4, D1, and D4—could not be identified in the distillate. Using a combination of ¹H NMR spectroscopy and gas chromatography (see below), the residue (5.24 g) was identified as a mixture dominated by D4 (4.61 g, 18.0 mmol, 90% yield), and with minor contributions from D1 (232 mg, 1.35 mmol, 7% yield) and A4 (140 mg, 0.81 mmol, 4% yield). A1: ¹H NMR (CDCl₃): 4.11 (q, ³J=7.1 Hz, 2H), 2.03 (s, 3H), 1.20 (t, ³J=7.1 Hz, 3H) ppm. ¹³C NMR (CDCl₃): 170.8, 60.1, 20.7, 13.9 ppm. Spectral data agree with a previous literature report.⁶ D4: ¹H NMR (CDCl₃): 4.04 (t, ³J=6.7 Hz, 2H), 2.28 (t, ³J=7.5 Hz, 1H), 1.60 (m, 4H), 1.29 (m, 18H), 0.86 (t, ³J=6.4 Hz, 6H) ppm. ¹³C NMR (CDCl₃): 174.08, 64.46, 34.47, 31.76 (2C), 29.29, 29.20, 29.03, 28.72 (2C), 25.11 (2C), 22.73, 22.69, 14.15 (2C) ppm. Spectral data agree with a previous literature report.⁷ Calculation of the Yields based on the Integration of ¹H NMR Spectra: Internal standard 1,3,5-trimethoxybenzene (38 mg, 0.23 mmol) was added to a 886 mg-aliquot of the distillate. From their relative integrals in the ¹H NMR spectrum (FIG. 10), the number of moles of A1 was calculated to be 0.23 mmol×29.5÷(⅔)=10.0 mmol. Thus, the total number of moles of A1 in the distillate was 10.0 mmol×1555 mg÷886 mg=17.6 mmol, corresponding to the yield of A1 of 17.6 mmol÷20.0 mmol×100%=88%. Minor fractions were not quantified because of the extensive overlap of their ¹H NMR spectral peaks.

Analogous yield calculation procedure was applied to the distillation residue: 1,3,5-trimethoxybenzene (36 mg, 0.21 mmol) was added to a 1043 mg-aliquot of the residue. Using this method, yields of intermediate volatility esters A4 and D1 could be estimated at 7% and 4%, respectively. The yield of D4—the major component in the distillation residue—was obtained using gas chromatography, because of (a) its complex spectrum which overlaps with some of its side products', and (b) possible overlap with some of the peaks of residual Ti(OBu)₄—which affected the ¹H NMR spectroscopic, but not the gas chromatographic measurements. (FIG. 10. ¹H NMR spectra of the starting mixture (bottom) of esters A1, A4, D1, and D4, and the distillate (middle) and distillation residue (top) obtained after the reactive distillation of that mixture).

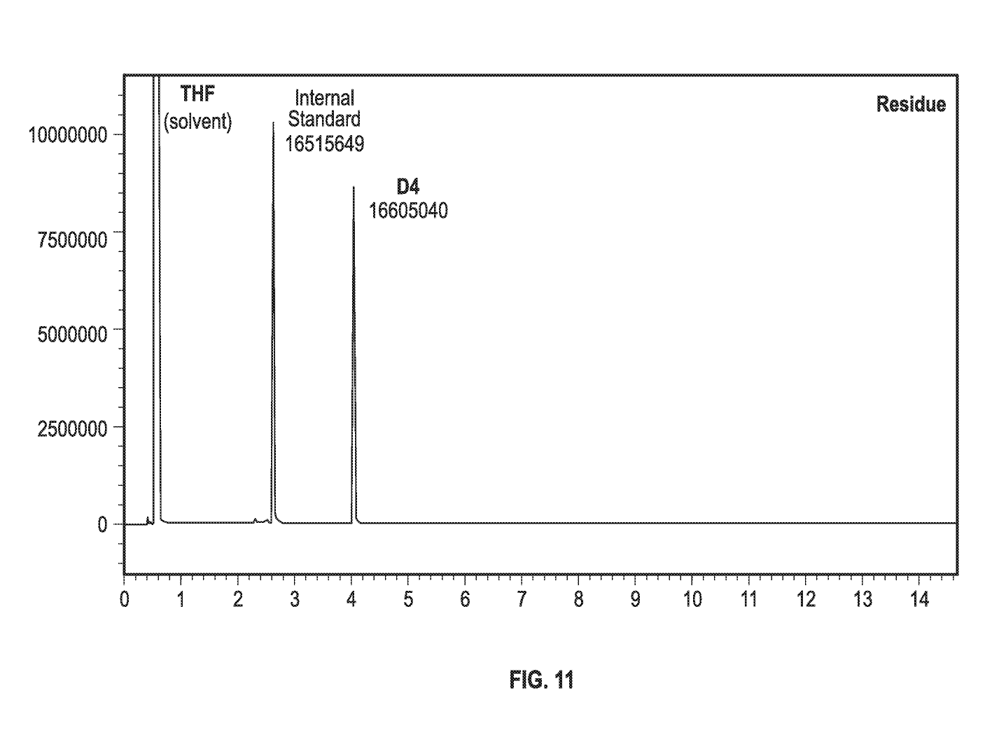

Calculation of the Yield of D4 based on the Integration of Gas Chromatogram (GC) Peaks: For the purpose of quantification of yield of D4, a response factor (F) for this ester with respect to dodecane was determined, which was used as GC internal standard. The area of ester signal/mass of ester=F×area of standard signal/mass of standard. That is, aₑ/mₑ=F×aₛ/mₑ. Therefore, aₑ and mₑ of a pure sample of D4 and aₛ and mₑ of GC internal standard (dodecane) were used to calculate F value. Five independent determinations of the F value were performed (0.787, 0.792, 0.760, 0.799, 0.803), yielding an average F=0.788. This value was then used to calculate the amount of D4 in the distillation residue of this reactive distillation (FIG. 11). A 43.3 mg-aliquot of the distillation residue was added to a glass vial, followed by addition of dodecane (29.9 mg) and THF (3 mL) as the solvent. The mixture was subjected to gas chromatography using the temperature program described in the General Methods section. From the integration, mass of D4 could be calculated as mₑ=(aₑ×mₛ)/(aₛ×F)=(16605040×29.9 mg)/(16515649×0.788)=38.1 mg. The total mass of D4 in the distillation residue was 38.1 mg×5.24 g÷43.3 mg=4.61 g. The yield of D4 is 4.61 g÷256.42 g mol⁻¹÷20.0 mmol×100%=90%. (FIG. 11. Gas chromatogram of the distillation residue from the reactive distillation of an equimolar mixture of A1, A4, D1, and D4, with internal standard (dodecane) added for calibration. THF was used as the solvent).

Butyl Butyrate (B2) and Octyl Octanoate (D4)

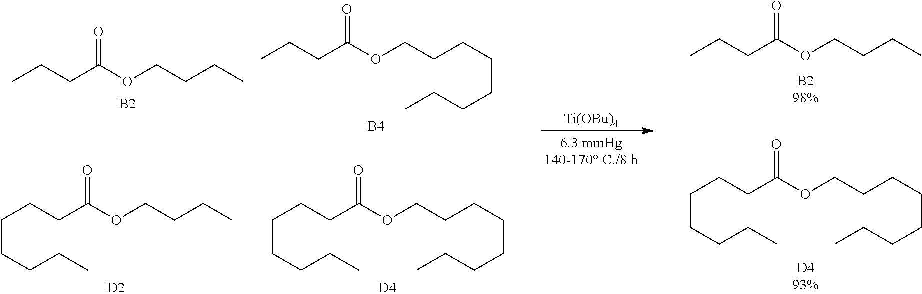

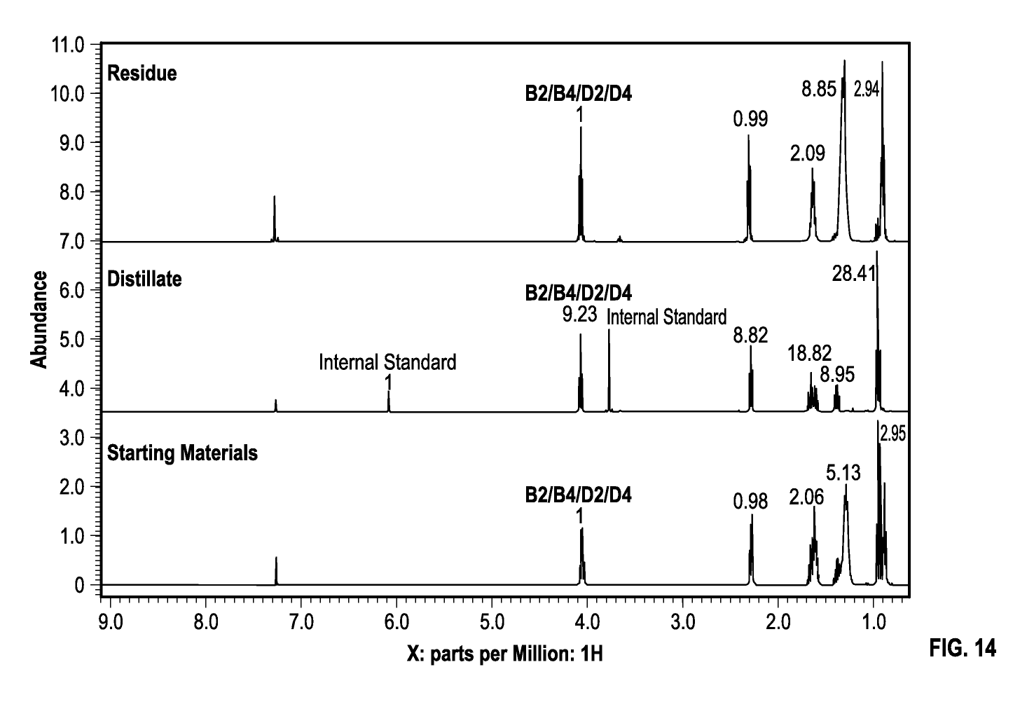

Titanium n-butoxide (138 mg, 0.40 mmol) and an equimolar mixture of B2 (1.46 g, 10.0 mmol), B4 (2.02 g, 10.0 mmol), D2 (2.02 g, 10.0 mmol), and D4 (2.59 g, 10.0 mmol) were added to a 100 mL round bottom flask. The reaction flask was equipped with a short path distillation head, which connected it to a receiving flask that was placed in an i-PrOH/CO₂ ice bath (−78° C.). This reaction was heated from 140 to 170° C. for 8 h under vacuum (6.3 mm Hg). Using gas chromatography, the distilled liquid (2.85 g) was identified as B2 (2.83 g, 19.6 mmol, 98% yield). The distillation residue (5.32 g) was analogously identified as a mixture dominated by D4 (4.51 g, 17.6 mmol, 93% yield), with minor contributions from D2 and B4, which could not be quantified individually as the peaks of these two compounds extensively overlap both in ¹H NMR spectra (FIG. 14) and in gas chromatograms. B2: ¹H NMR (CDCl₃): 4.07 (t, ³J=6.8 Hz, 2H), 2.27 (t, ³J=7.5 Hz, 2H), 1.69-1.40 (m, 6H) 0.9 (t, ³J=6.4 Hz, 6H) ppm. ¹³C NMR (CDCl₃): 173.77, 64.06, 36.26, 30.74, 19.17, 18.50, 13.70, 13.66 ppm. Spectral data agree with a previous literature report.² D4: ¹H NMR (CDCl₃): 4.04 (t, ³J=6.7 Hz, 2H), 2.28 (t, ³J=7.5 Hz, 1H), 1.60 (m, 4H), 1.29 (m, 18H), 0.86 (t, ³J=6.4 Hz, 6H) ppm. ¹³C NMR (CDCl₃): 174.08, 64.46, 34.47, 31.76 (2C), 29.29, 29.20, 29.03, 28.72 (2C), 25.11 (2C), 22.73, 22.69, 14.15 (2C) ppm. Spectral data agree with a previous literature report.⁷

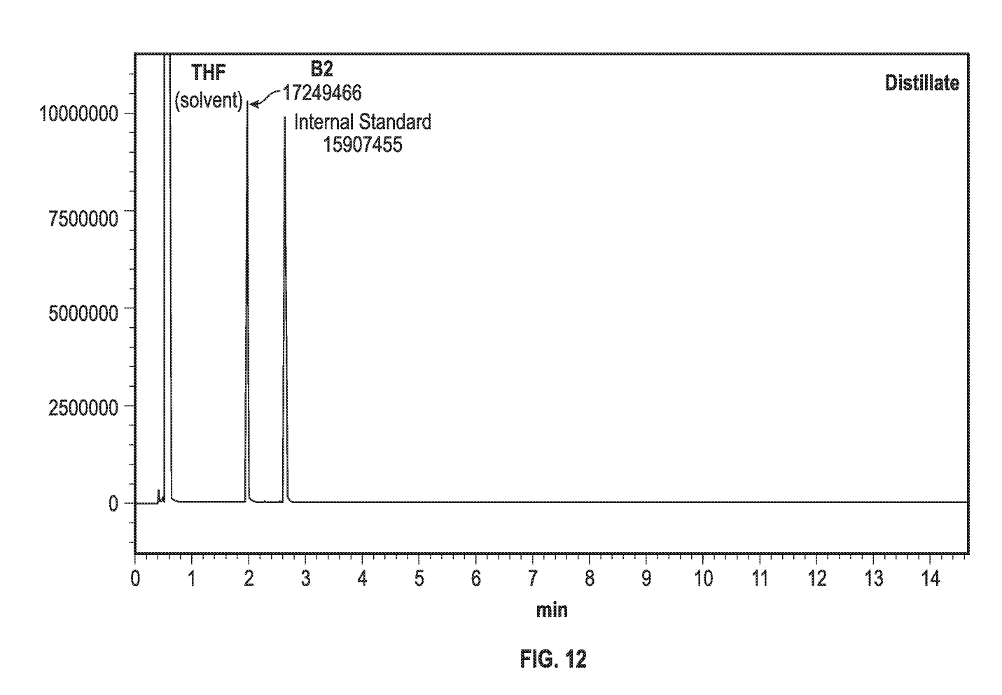

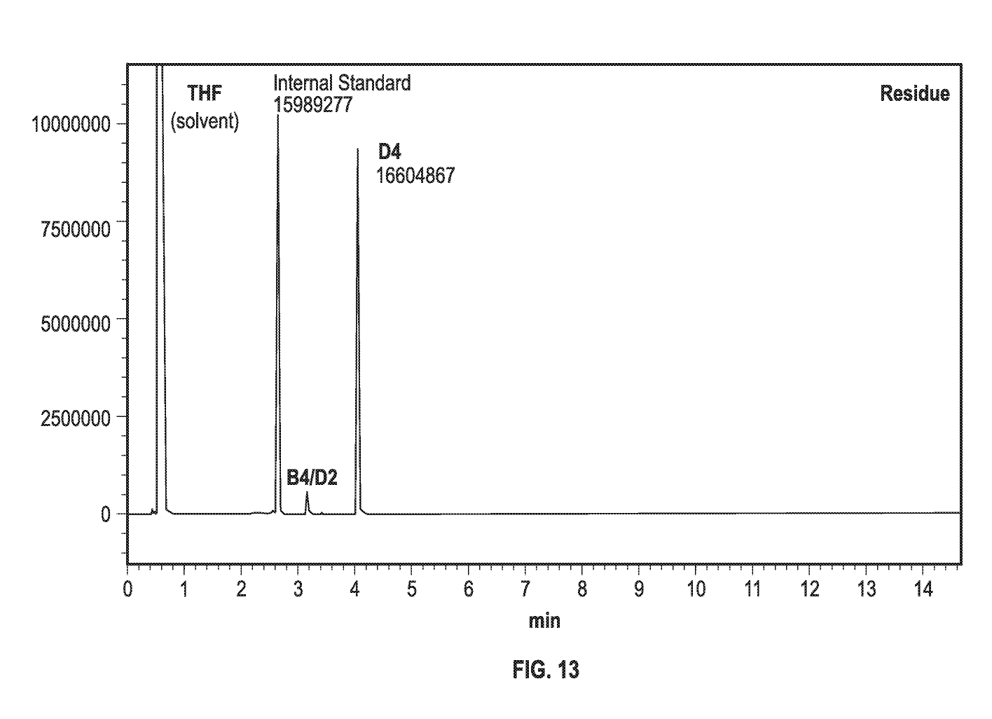

Calculation of the Yields of B2 and D4 based on the Integration of Gas Chromatogram (GC) Peaks: For the purpose of quantification of yields of B2 and D4, response factors (F) were determined for these esters with respect to dodecane as the GC internal standard. The area of ester signal/mass of ester=F×area of standard signal/mass of standard. That is, aₑ/mₑ=F×aₛ/mₛ. Therefore, aₑ and mₑ of a pure samples of B2 and D4 and aₛ and mₛ of GC internal standard (dodecane) were used to calculate F value. Five independent determinations of the F value were performed for B2 (0.624, 0.658, 0.663, 0.653, 0.658), yielding an average F=0.651 for B2. Five independent determinations of the F value were performed for D4 (0.787, 0.792, 0.760, 0.799, 0.803), yielding an average F=0.788 for D4. This value was then used to calculate the amounts of B2 and D4 in the distillate and distillation residue of this reactive distillation (Figures S7 and S8, respectively). A 47.4 mg-aliquot of the distillate was added to a glass vial, followed by addition of dodecane (28.3 mg) and THF (3 mL) as the solvent. The mixture was subjected to gas chromatography using the temperature program described in the General Methods section. From the integration, mass of B2 could be calculated as mₑ=(aₑ×mₛ)/(aₛ×F)=(17249466×28.3 mg)/(15907455×0.651)=47.1 mg. The total mass of B2 in the distillation residue was 47.1 mg×2.85 g÷47.4 mg=2.83 g. The yield of B2 is 2.83 g÷144.21 g mol⁻¹÷20.0 mmol×100%=98%. (FIG. 12. Gas chromatogram of the distillate from the reactive distillation of a mixture of B2, B4, D2, and D4, with internal standard (dodecane) added for calibration. THF was used as the solvent). FIG. 13. Gas chromatogram of the distillation residue from the reactive distillation of a mixture of B2, B4, D2, and D4, with internal standard (dodecane) added for calibration. THF was used as the solvent.

A 41.4 mg-aliquot of the distillation residue was added to a glass vial, followed by addition of dodecane (28.2 mg) and THF (3 mL) as the solvent. The mixture was subjected to gas chromatography using the temperature program described in the General Methods section. From the integration, mass of D4 could be calculated as mₑ=(aₑ×mₛ)/(aₛ×F)=(16604867×28.2 mg)/(15989277×0.788)=37.2 mg. The total mass of D4 in the distillation residue was 37.2 mg×5.32 g÷41.4 mg=4.78 g. The yield of D4 is 4.78 g÷256.42 g mol⁻¹÷20.0 mmol×100%=93%. (FIG. 14. ¹H NMR spectra of the starting mixture (bottom) of esters B2, B4, D2, and D4, and the distillate (middle) and distillation residue (top) obtained after the reactive distillation of that mixture).

Reactive Distillations of [3×3] Ester Libraries

Ethyl Acetate (A1), Butyl Butyrate (B2), and Benzyl Benzoate (C3)

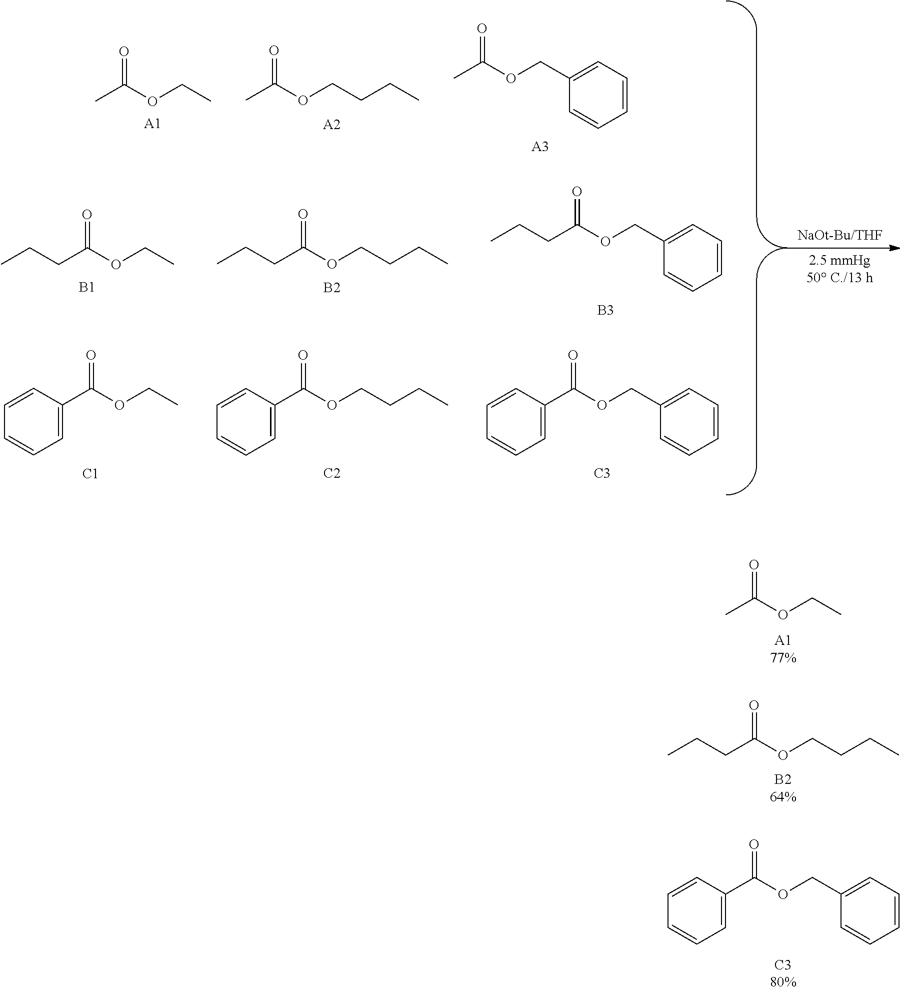

An equimolar mixture of A1 (890 mg, 10.0 mmol), B1 (1.17 g, 10.0 mmol), C1 (1.56 g, 10.0 mmol), A2 (1.17 g, 10.0 mmol), B2 (1.46 mg, 10.0 mmol), C2 (1.80 g, 10.0 mmol), A3 (1.52 g, 10.0 mmol), B3 (1.80 g, 10.0 mmol), and C3 (2.14 g, 10.0 mmol) was added to a 25 mL two-neck round bottom flask. The reaction flask was equipped with a 185 mm-long Vigreux column that was cooled by an i-PrOH/CO₂ cold trap (−55 to −50° C.). Short path distillation head was placed on top of the Vigreux column, connecting it to a receiving flask, which was placed into a separate i-PrOH/CO₂ ice bath (−78° C.). A 0.05 mL-portion of a 1M solution of NaOt-Bu in THF was injected into the reaction flask every 30 min for 10 h. Vacuum (2.5 mmHg) was started at the same time as the first loading of catalyst. The first step of this distillation was carried out at 50° C. over the course of 10 h. The first distillate was collected as a colorless liquid. ¹H NMR spectroscopy confirmed the identity of this liquid as a mixture of A1 (2.03 g, 23.1 mmol, 77% yield), A2 (41.4 mg, 0.36 mmol, 1% yield), B1 (91.0 mg, 0.78 mmol, 3% yield), and THF (solvent, 2.59 g, 35.9 mmol). The second distillate was collected after another 10 h of distillation without the Vigreux column, during which a 0.05 mL-portion of a 1M solution of NaOt-Bu in THF was injected into the reaction flask every 30 min. ¹H NMR spectroscopy confirmed the identity of this liquid as a mixture of B2 (2.76 g, 19.2 mmol, 64% yield), A2 (205 mg, 1.76 mmol, 6% yield), B1 (37.5 mg, 0.32 mmol, 1% yield), B3 (54.9 mg, 0.31 mmol, 1% yield), C2 (47.9 mg, 0.27 mmol, 1% yield), and THF (solvent, 1.43 g, 19.9 mmol). The residue was identified by ¹H NMR spectroscopy as a mixture of C3 (5.11 g, 24.1 mmol, 80% yield), B3 (473 mg, 2.66 mmol, 9% yield), and C2 (452 mg, 2.54 mmol, 8% yield). A1: ¹H NMR (CDCl₃): 4.11 (q, ³J=7.1 Hz, 2H), 2.03 (s, 3H), 1.20 (t, ³J=7.1 Hz, 3H) ppm. ¹³C NMR (CDCl₃): 170.8, 60.1, 20.7, 13.9 ppm. Spectral data agree with a previous literature report.⁶ B2: ¹H NMR (CDCl₃): 4.07 (t, ³J=6.8 Hz, 2H), 2.27 (t, ³J=7.5 Hz, 2H), 1.69-1.40 (m, 6H) 0.9 (t, ³J=6.4 Hz, 6H) ppm. ¹³C NMR (CDCl₃): 173.77, 64.06, 36.26, 30.74, 19.17, 18.50, 13.70, 13.66 ppm. Spectral data agree with a previous literature report.² C3: ¹H NMR (CDCl₃): 8.10 (d, ³J=7.0 Hz, 2H), 7.59 (t, ³J=7.5 Hz, 1H), 7.37-7.50 (m, 7H), 5.40 (s, 2H) ppm. ¹³C NMR (CDCl₃): 166.54, 136.26, 133.21, 130.32, 129.89, 128.78, 128.57, 128.43, 128.36, 66.84 ppm. Spectral data agree with a previous literature report.⁵

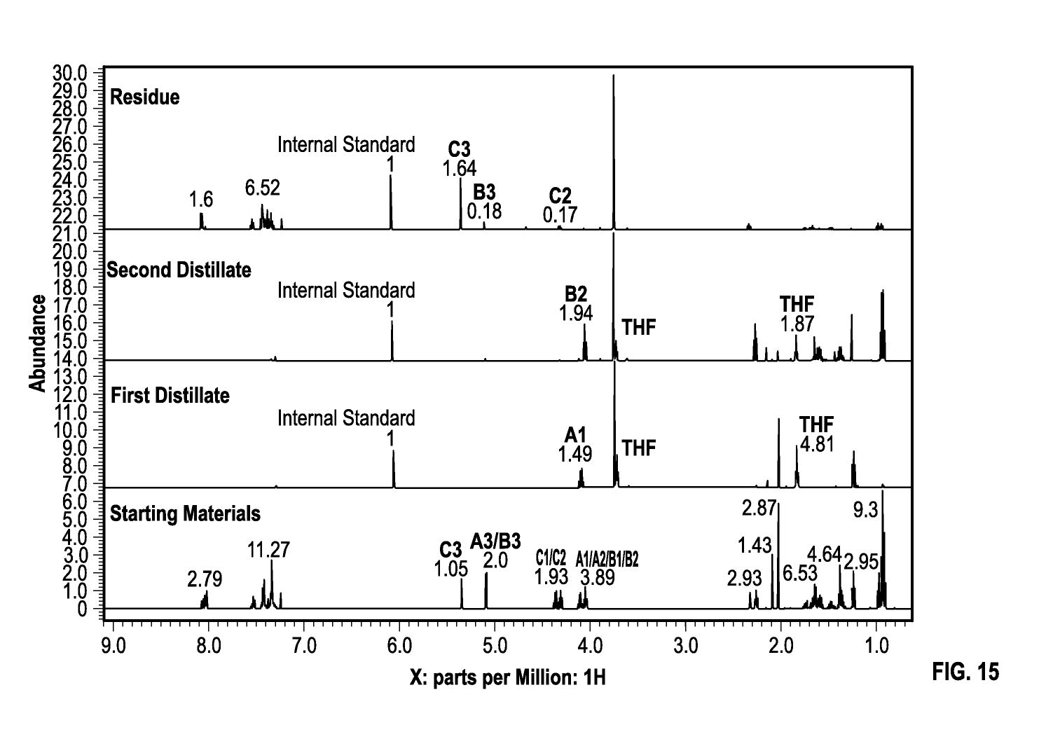

Calculation of the yields based on the Integration of ¹H NMR Spectra: Internal standard 1,3,5-trimethoxybenzene (173 mg, 1.02 mmol) was added to a 512 mg-aliquot of the first distillate. From their relative integrals in the ¹H NMR spectrum (FIG. 15), the number of moles of A1 was calculated to be 1.02 mmol×1.49÷(⅔)=2.27 mmol. Thus, the total number of moles of A1 in the first distillate was 2.27 mmol×5210 mg÷512 mg=23.1 mmol, corresponding to the yield of A1 of 23.1 mmol÷30.0 mmol×100%=77%. Analogous calculation allowed us to estimate the yields of minor fractions A2 and B1 at 1% and 3%, respectively.

Similar yield calculation procedure was applied to the second distillate: 1,3,5-trimethoxybenzene (163 mg, 0.96 mmol) was added to a 569 mg-aliquot of the residue. The number of moles of B2 in the aliquot was calculated to be 0.96 mmol×[1.94−(0.32×⅔)]÷(⅔)=2.49 mmol. The total number of moles of B2 in the whole of the second distillate was 2.49 mmol×4379 mg÷569 mg=19.2 mmol, corresponding to the yield of 19.2 mmol÷30.0 mmol×100%=64%. Equivalent calculation allowed us to estimate the yields of minor fractions A2, B1, B3, and C1 at 6%, 1%, 1%, and 1%, successively.

Analogous yield calculation procedure was applied to the distillation residue as well: 1,3,5-trimethoxybenzene (181 mg, 1.07 mmol) was added to a 712 mg-aliquot of the residue. The number of moles of C3 in the aliquot was calculated to be 1.07 mmol×1.64÷(⅔)=2.62 mmol. The total number of moles of C3 in the whole of the distillation residue was 2.62 mmol×6539 mg÷712 mg=24.1 mmol, corresponding to the yield of 24.1 mmol÷30.0 mmol×100%=80%. Analogous calculation allowed us to estimate the yields of minor fractions B3 and C2 at 9% and 8%, respectively. FIG. 15. ¹H NMR spectra of the starting mixture (bottom) of esters A1-C3, and the two distillates (middle) and distillation residue (top) obtained after the reactive distillation of that mixture.

Ethyl Acetate (A1), Butyl Butyrate (B2), and Octyl Octanoate (D4)

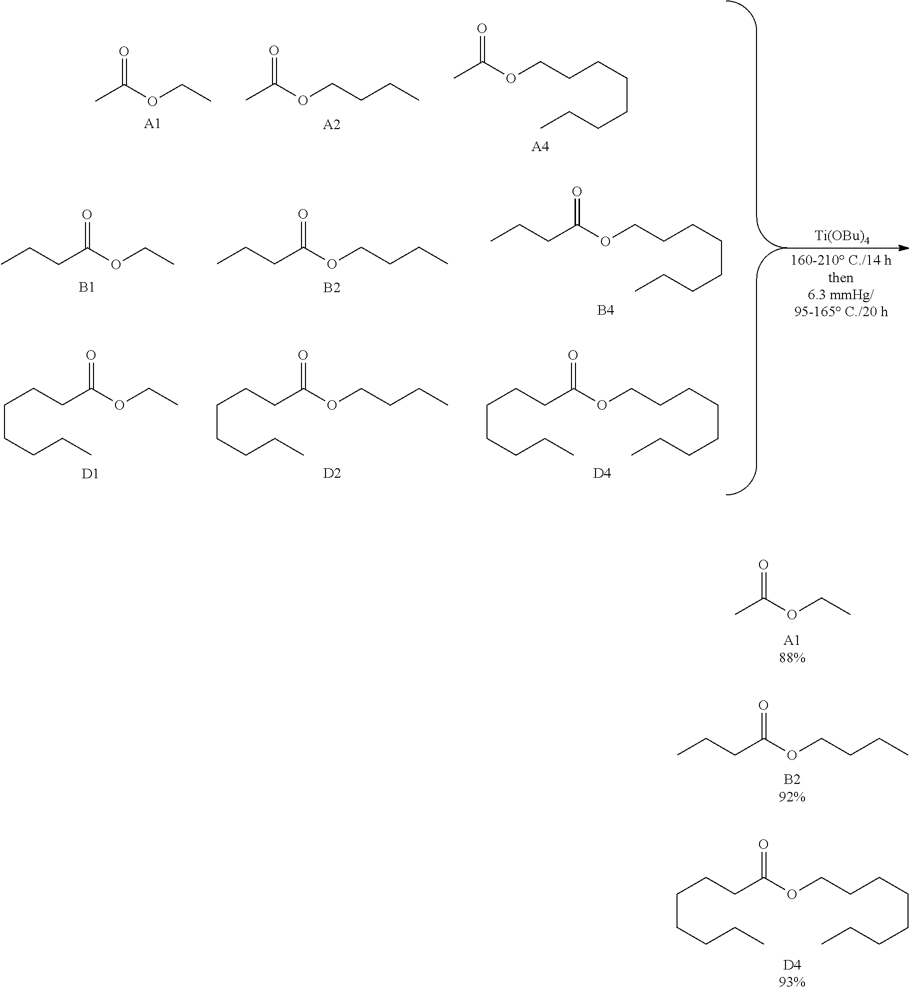

Titanium n-butoxide (0.93 g, 2.70 mmol) and an equimolar mixture of A1 (2.67 g, 30.0 mmol), A2 (3.52 g, 30.0 mmol), A4 (5.22 g, 30.0 mmol), B1 (3.52 g, 30.0 mmol), B2 (4.37 g, 30.0 mmol), B4 (6.07 g, 30.0 mmol), D1 (5.22 g, 30.0 mmol), D2 (6.07 g, 30.0 mmol), and D4 (7.77 g, 30.0 mmol) was added to a 100 mL round bottom flask. The flask was fitted with a Vigreux column, and a short path distillation head was used to connect it to a receiving flask, which was placed in an i-PrOH/CO₂ ice bath (−78° C.). The first step of the distillation was carried out at atmospheric pressure for 14 h, with temperature slowly being raised from 160 to 210° C. The first distillate (9.51 g) was collected as a colorless liquid. ¹H NMR spectroscopy confirmed the identity of this liquid as a mixture dominated by A1 (7.01 g, 79.6 mmol, 88% yield), and with minor contributions from A2 and B1. The reaction flask was then equipped with a 185 mm-long Vigreux column and placed under vacuum (6.25 mmHg) for the second step of the distillation. The second distillate (12.0 g) was collected after another 9.5 hours. ¹H NMR spectroscopy confirmed the identity of this liquid as a mixture of B2 (11.9 g, 82.8 mmol, 92% yield) and small amounts of A2 and B1. Finally, the distillation residue (24.0 g) was identified by ¹H NMR spectroscopy and gas chromatography as a mixture of D4 (21.5 g, 82.8 mmol, 93% yield) and small amounts of D2 and B4. A1: ¹H NMR (CDCl₃): 4.11 (q, ³J=7.1 Hz, 2H), 2.03 (s, 3H), 1.20 (t, ³J=7.1 Hz, 3H) ppm. ¹³C NMR (CDCl₃): 170.8, 60.1, 20.7, 13.9 ppm. Spectral data agree with a previous literature report.⁶ B2: ¹H NMR (CDCl₃): 4.07 (t, ³J=6.8 Hz, 2H), 2.27 (t, ³J=7.5 Hz, 2H), 1.69-1.40 (m, 6H) 0.9 (t, ³J=6.4 Hz, 6H) ppm. ¹³C NMR (CDCl₃): 173.77, 64.06, 36.26, 30.74, 19.17, 18.50, 13.70, 13.66 ppm. Spectral data agree with a previous literature report.² D4: ¹H NMR (CDCl₃): 4.04 (t, ³J=6.7 Hz, 2H), 2.28 (t, ³J=7.5 Hz, 1H), 1.60 (m, 4H), 1.29 (m, 18H), 0.86 (t, ³J=6.4 Hz, 6H) ppm. ¹³C NMR (CDCl₃): 174.08, 64.46, 34.47, 31.76 (2C), 29.29, 29.20, 29.03, 28.72 (2C), 25.11 (2C), 22.73, 22.69, 14.15 (2C) ppm. Spectral data agree with a previous literature report.⁷

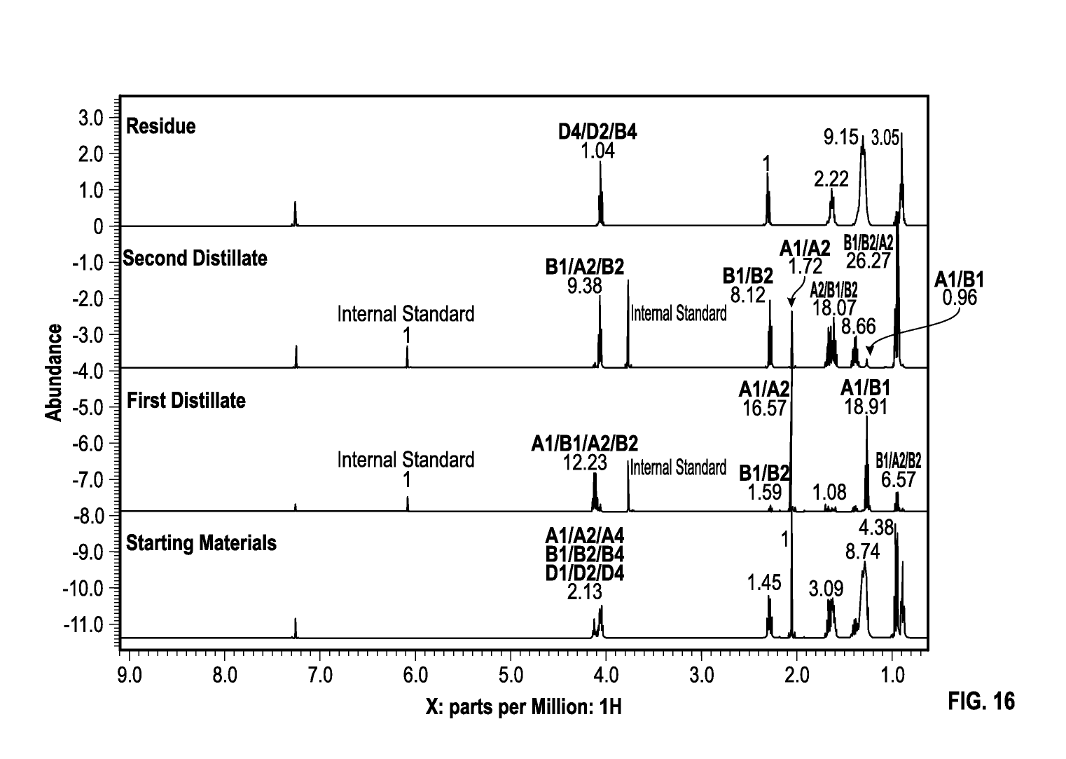

Calculation of the Yields based on the Integration of ¹H NMR Spectra: Internal standard 1,3,5-trimethoxybenzene (81 mg, 0.48 mmol) was added to a 808 mg-aliquot of the first distillate. From their relative integrals in the ¹H NMR spectrum (FIG. 16), the number of moles of A1 was calculated to be 0.48 mmol×[16.57−(1.59×1.5)]=6.77 mmol. Thus, the total number of moles of A1 in the first distillate was 6.77 mmol×9510 mg÷808 mg=79.6 mmol, corresponding to the yield of A1 of 79.6 mmol÷90.0 mmol×100%=88%.

Similar yield calculation procedure was applied to the second distillate: 1,3,5-trimethoxybenzene (97 mg, 0.57 mmol) was added to a 930 mg-aliquot of the residue. The number of moles of B2 in the aliquot was calculated to be 0.57 mmol×[(8.12−0.96×(⅔))]÷(⅔)=6.38 mmol. The total number of moles of B2 in the whole of the second distillate was 6.38 mmol×12030 mg÷930 mg=82.6 mmol, corresponding to the yield of 82.6 mmol÷90.0 mmol×100%=92%. Yield of D4 was calculated from gas chromatography data, as described below.

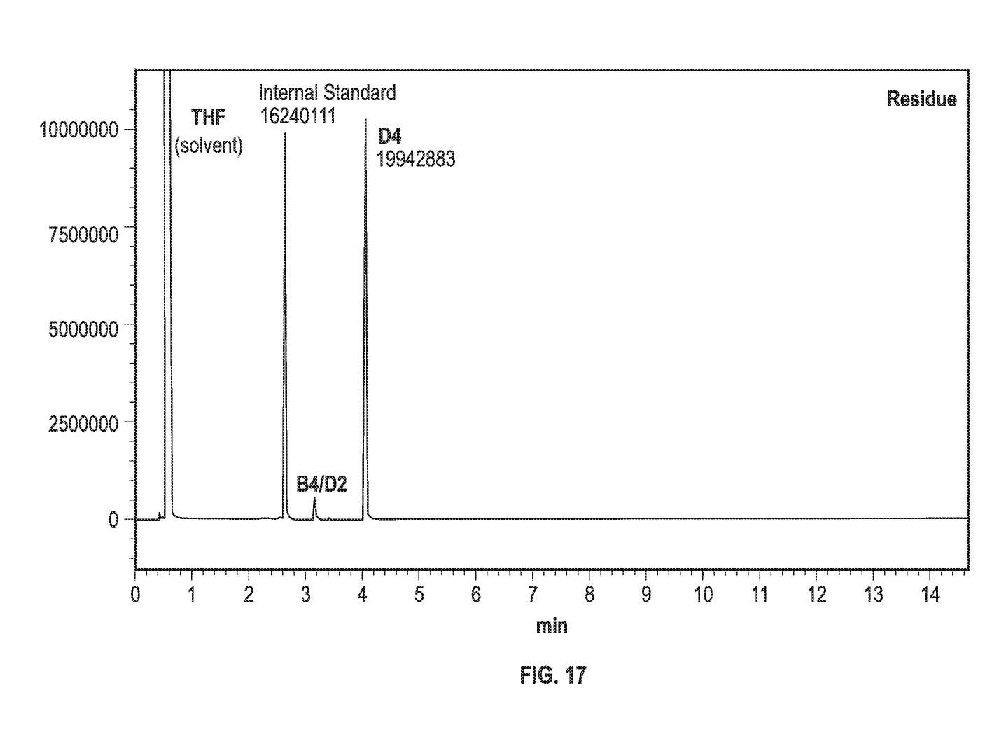

Calculation of the Yield of D4 based on the Integration of Gas Chromatogram (GC) Peaks: For the purpose of quantification of yield of D4, a response factor (F) for this ester was determined with respect to Dodecane, which was used as GC internal standard. The area of ester signal/mass of ester=F×area of standard signal/mass of standard. That is, aₑ/mₑ=F×aₛ/mₑ. Therefore, aₑ and mₑ of a pure sample of D4 and aₛ and mₑ of GC internal standard (dodecane) were used to calculate F value. Five independent determinations of the F value were performed (0.787, 0.792, 0.760, 0.799, 0.803), yielding an average F=0.788. This value was then used to calculate the amount of D4 in the distillation residue of this reactive distillation (FIG. 17). A 48.8 mg-aliquot of the distillation residue was added to a glass vial, followed by addition of dodecane (28.1 mg) and THF (3 mL) as the solvent. The mixture was subjected to gas chromatography using the temperature program described in the General Methods section. From the integration, mass of D4 could be calculated as mₑ=(aₑ×mₑ)/(aₛ×F)=(19942883×28.1 mg)/(16240111×0.788)=43.8 mg. The total mass of D4 in the distillation residue was 43.8 mg×24.0 g÷48.8 mg=21.5 g. The yield of D4 is 21.5 g÷256.42 g mol⁻¹÷90.0 mmol×100%=93%. (FIG. 16. ¹H NMR spectra of the starting mixture (bottom) of esters A1, A2, A4, B1, B2, B4, D1, D2, and D4, and the two distillates (middle) and distillation residue (top) obtained after the reactive distillation of that mixture. FIG. 17. Gas chromatogram of the distillation residue from the reactive distillation of an equimolar mixture of A1, A2, A4, B1, B2, B4, D1, D2, and D4, with internal standard (dodecane) added for calibration. THF was used as the solvent).

Reactive Distillation of a [4×4] Ester Library

Ethyl Acetate (A1), Butyl Butyrate (B2), Octyl Octanoate (D4), and Cetyl Palmitate (E5)

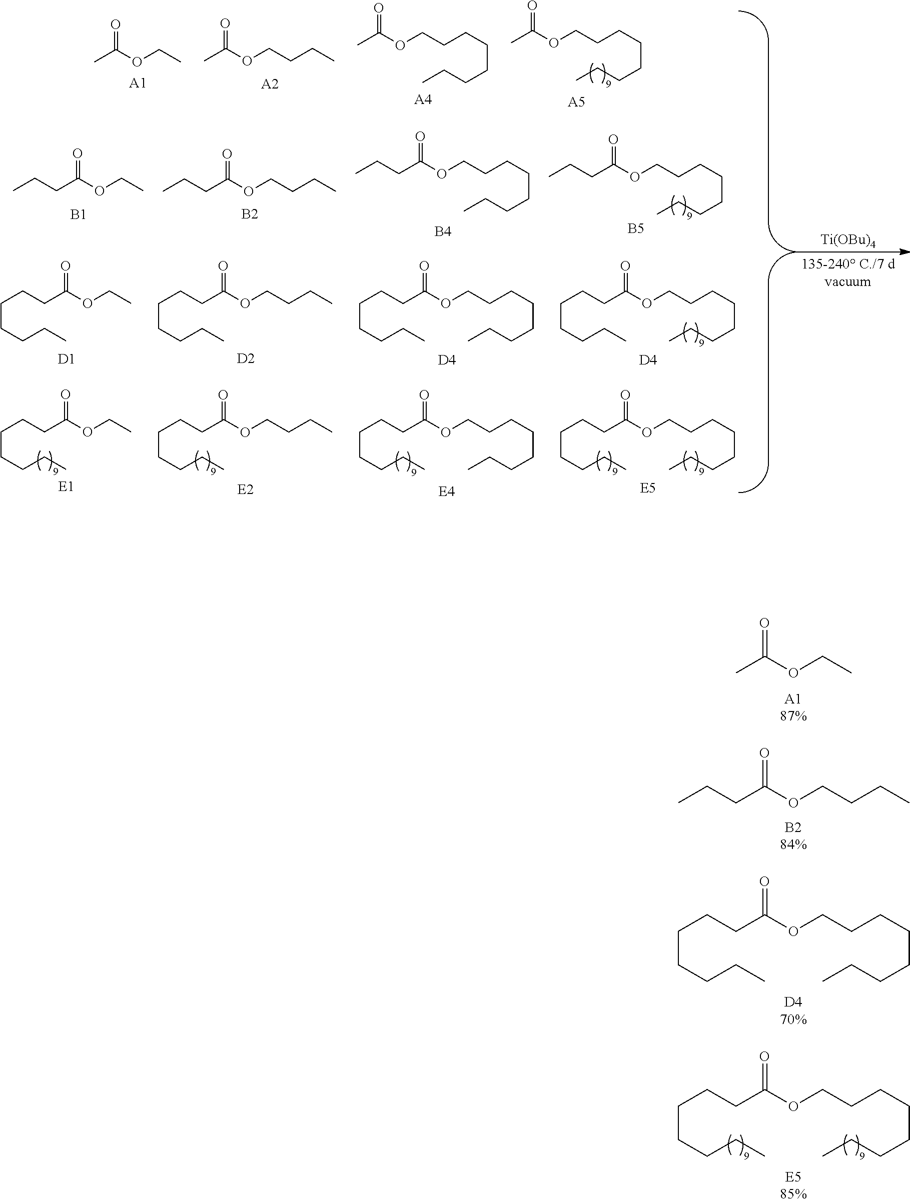

Titanium n-butoxide (0.50 mL, 49.8 mg, 1.46 mmol) and an equimolar mixture of A1 (0.89 g, 10.0 mmol), A2 (1.17 g, 10.0 mmol), A4 (1.74 g, 10.0 mmol), A5 (2.90 g, 10.0 mmol), B1 (1.17 g, 10.0 mmol), B2 (1.46 g, 10.0 mmol), B4 (2.02 g, 10.0 mmol), B5 (3.19 g, 10.0 mmol), D1 (1.74 g, 10.0 mmol), D2 (2.02 g, 10.0 mmol), D4 (2.59 g, 10.0 mmol), D5 (3.76 g, 10.0 mmol), E1 (2.90 g, 10.0 mmol), E2 (3.19 g, 10.0 mmol), E4 (3.76 g, 10.0 mmol), and E5 (4.91 g, 10.0 mmol) were placed into a 100 mL round bottom flask. Short path distillation head was used to connect the reaction flask with a receiving flask, which was placed in a liquid N₂ bath (−196° C.). The first step of the distillation was performed at atmospheric pressure over 72 h and the mixture was gradually heated up from 170 to 240° C. The first distillate (3.50 g) was collected as a colorless liquid, and ¹H NMR spectroscopy of this liquid confirmed its identity as a mixture of A1 (3.07 g, 34.9 mmol, 87% yield) and A2 and B1 as trace components. The reaction flask was then equipped with a 100 mm-long Vigreux column and placed under vacuum (6.3 mmHg) for the second step of the distillation. The second distillate (7.00 g) was collected after the mixture was heated from 135 to 195° C. during the course of additional 45 h. The temperature was slowly increased from 135 to 155° C. in the first 4 h and additional Ti(OBu)₄ (0.10 mL, 99.6 mg, 0.29 mmol) was added to the reaction flask. Temperature was then increased from 155 to 165° C. for 6 h and another portion of Ti(OBu)₄ (0.10 mL, 99.6 mg, 0.29 mmol) was added to the reaction flask. Finally, temperature was increased from 165 to 190° C. over the course of 19 h and the final portion of Ti(OBu)₄ (0.10 mL, 99.6 mg, 0.29 mmol) was added to the reaction flask. Temperature was brought from 190 to 195° C. over the course of last 16 h. Using a combination of ¹H NMR spectroscopy and gas chromatography, the second distillate was identified as a mixture of B2 (4.86 g, 33.7 mmol, 84% yield), and minute amounts of A2 and B1. The third distillate (9.70 g) was collected after high vacuum (0.10 mm Hg) distillation at temperature from 200 to 240° C. during the course of another 24 h. The temperature was slowly increased from 200 to 240° C. in the first 4 h, followed by the addition of Ti(OBu)₄ (0.10 mL, 99.6 mg, 0.29 mmol) to the reaction flask. The Vigreux column was removed and the mixture was heated from 205 to 220° C. for 4 h, followed by another portion of Ti(OBu)₄ (0.10 mL, 99.6 mg, 0.29 mmol). Finally, the temperature was increased from 220 to 240° C. for 4 h and the temperature was kept at 240° C. for 12 h. A combination of ¹H NMR spectroscopy and gas chromatography confirmed the identity of the third distillate liquid as a mixture of D4 (7.40 g, 28.9 mmol, 72% yield) and small amounts of B4 and D2. The residue (20.3 g) was identified by ¹H NMR spectroscopy and gas chromatography as a mixture of E5 (17.2 g, 35.8 mmol, 90% yield) and small amounts of D5 and E4. A1: ¹H NMR (CDCl₃): 4.11 (q, ³J=7.1 Hz, 2H), 2.03 (s, 3H), 1.20 (t, ³J=7.1 Hz, 3H) ppm. ¹³C NMR (CDCl₃): 170.8, 60.1, 20.7, 13.9 ppm. Spectral data agree with a previous literature report.⁶ B2: ¹H NMR (CDCl₃): 4.07 (t, ³J=6.8 Hz, 2H), 2.27 (t, ³J=7.5 Hz, 2H), 1.69-1.40 (m, 6H) 0.9 (t, ³J=6.4 Hz, 6H) ppm. ¹³C NMR (CDCl₃): 173.77, 64.06, 36.26, 30.74, 19.17, 18.50, 13.70, 13.66 ppm. Spectral data agree with a previous literature report.² D4: ¹H NMR (CDCl₃): 4.04 (t, ³J=6.7 Hz, 2H), 2.28 (t, ³J=7.5 Hz, 1H), 1.60 (m, 4H), 1.29 (m, 18H), 0.86 (t, ³J=6.4 Hz, 6H) ppm. ¹³C NMR (CDCl₃): 174.08, 64.46, 34.47, 31.76 (2C), 29.29, 29.20, 29.03, 28.72 (2C), 25.11 (2C), 22.73, 22.69, 14.15 (2C) ppm. Spectral data agree with a previous literature report.⁷ E5: ¹H NMR (CDCl₃): 4.04 (t, ³J=6.7 Hz, 2H), 2.28 (t, ³J=7.5 Hz, 2H), 1.57-1.61 (m, 4H), 1.24-1.29 (m, 50H), 0.85-0.88 (m, 6H) ppm. ¹³C NMR (CDCl₃): 174.16, 64.51, 34.64, 32.03, 29.80, 29.58, 29.48, 29.38, 28.74, 26.04, 25.13, 22.80, 14.23 ppm. Spectral data agree with a previous literature report.⁸

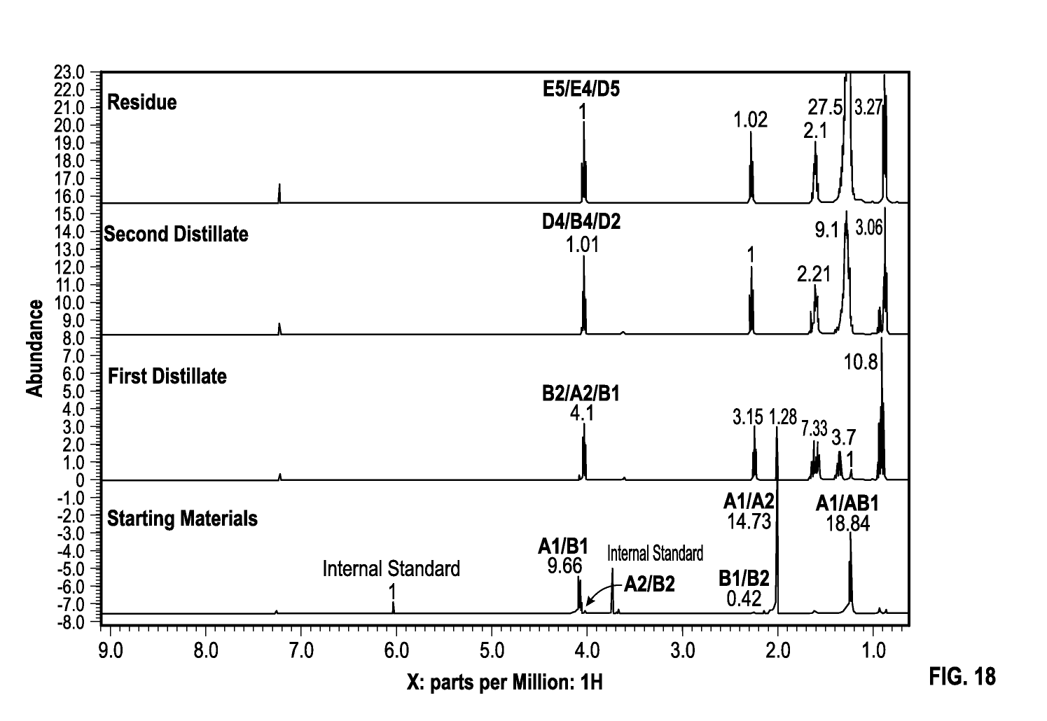

Calculation of the Yields based on the Integration of ¹H NMR Spectra: Internal standard 1,3,5-trimethoxybenzene (80.5 mg, 0.47 mmol) was added to a 670 mg-aliquot of the distillate. From their relative integrals in the ¹H NMR spectrum (FIG. 18), the number of moles of A1 was calculated as 0.47 mmol×[14.73−(0.42×1.5)]=6.68 mmol. Thus, the total number of moles of A1 in the distillate was 6.68 mmol×3500 mg÷670 mg=34.9 mmol, corresponding to the yield of A1 of 34.9 mmol÷40.0 mmol×100%=87%.

Calculation of the Yields based on the Integration of Gas Chromatogram Peaks: For the purpose of quantification of yields of B2, D4, and E5 response factors (F) was determined for these esters with respect to dodecane as the GC internal standard. The area of ester signal/mass of ester=F×area of standard signal/mass of standard. That is, aₑ/mₑ=F×aₛ/mₛ. Therefore, aₑ and mₑ of a pure samples of B2, D4, and E5, and aₛ and mₛ of GC internal standard (dodecane) were used to calculate F values. Five independent determinations of the F value were performed for B2 (0.624, 0.658, 0.663, 0.653, 0.658), yielding an average F=0.651 for B2. Five independent determinations of the F value were performed for D4 (0.787, 0.792, 0.760, 0.799, 0.803), yielding an average F=0.788 for D4. Four independent determinations of the F value were performed for E5 (0.863, 0.857, 0.882, 0.828), yielding an average F=0.857 for E5. These values were then used to calculate the amounts of B2, D4, and E5 in the distillates and distillation residue of this reactive distillation (Figures S14, S15, and S16, successively). A 50.5 mg-aliquot of the first distillate was added to a glass vial, followed by addition of dodecane (28.7 mg) and THF (3 mL) as the solvent. The mixture was subjected to gas chromatography using the temperature program described in the General Methods section. From the integration, mass of B2 could be calculated as mₑ=(aₑ×mₛ)/(aₛ×F)=(13392345×28.7 mg)/(16122856×0.651)=36.6 mg. The total mass of B2 in the distillation residue was 36.6 mg×7.00 g÷50.5 mg=5.07 g. The yield of B2 is 5.07 g÷144.21 g mol⁻¹÷40.0 mmol×100%=88%.

A 43.5 mg-aliquot of the second distillate was added to a glass vial, followed by addition of dodecane (30.3 mg) and THF (3 mL) as the solvent. The mixture was subjected to gas chromatography using the temperature program described in the General Methods section. From the integration, mass of D4 could be calculated as mₑ=(aₑ×mₛ)/(aₛ×F)=(14360829×30.3 mg)/(17269926×0.788)=32.0 mg. The total mass of D4 in the distillation residue was 32.0 mg×9.70 g÷43.5 mg=7.14 g. The yield of D4 is 7.14 g÷256.42 g mol⁻¹÷40.0 mmol×100%=70%.

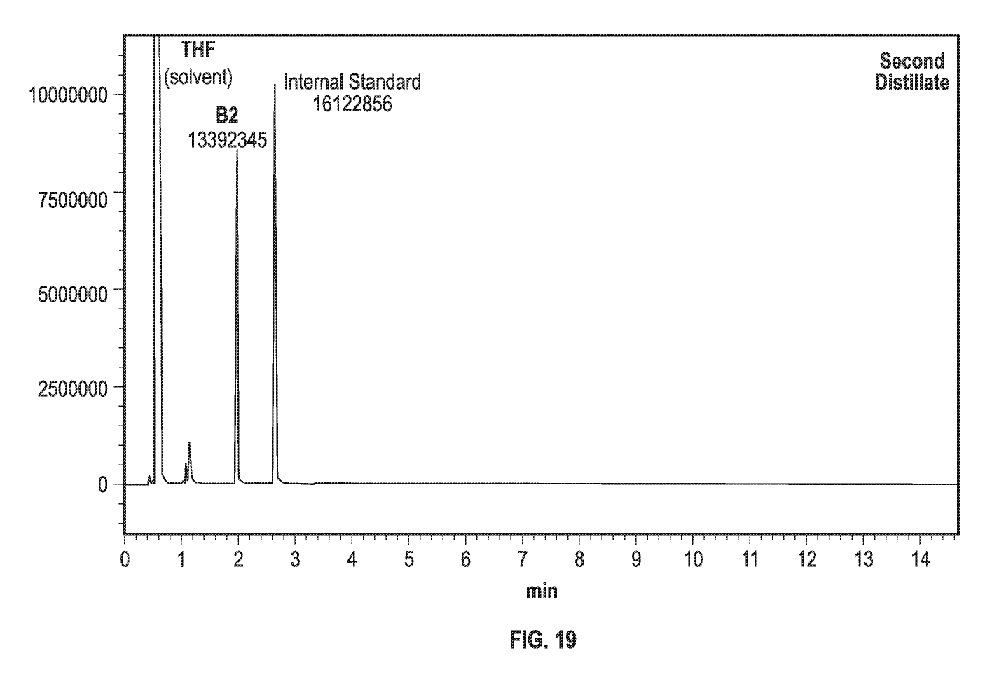

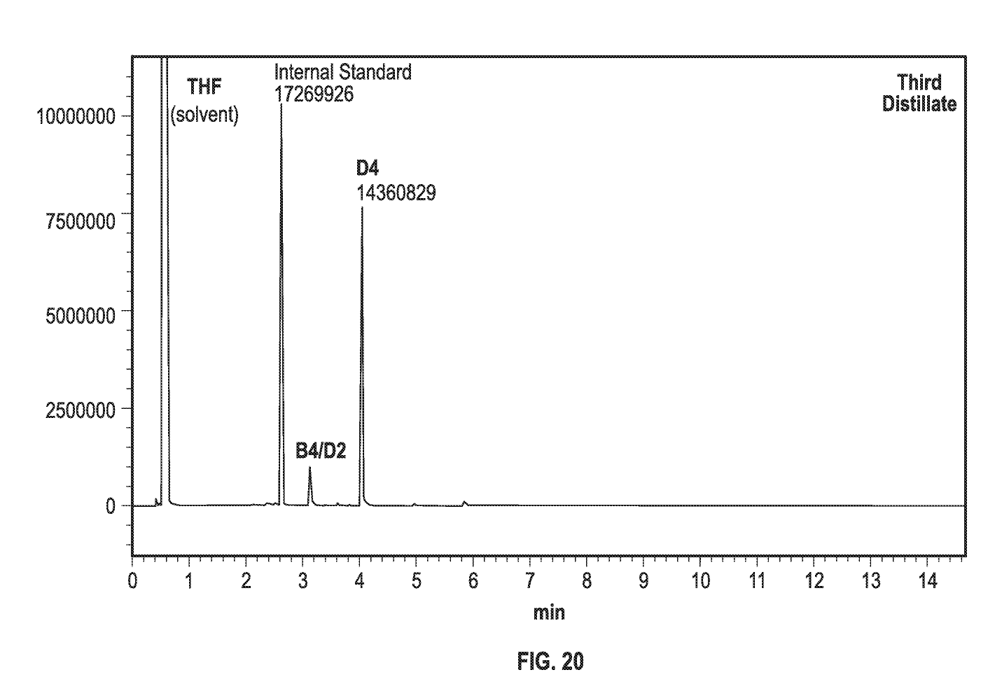

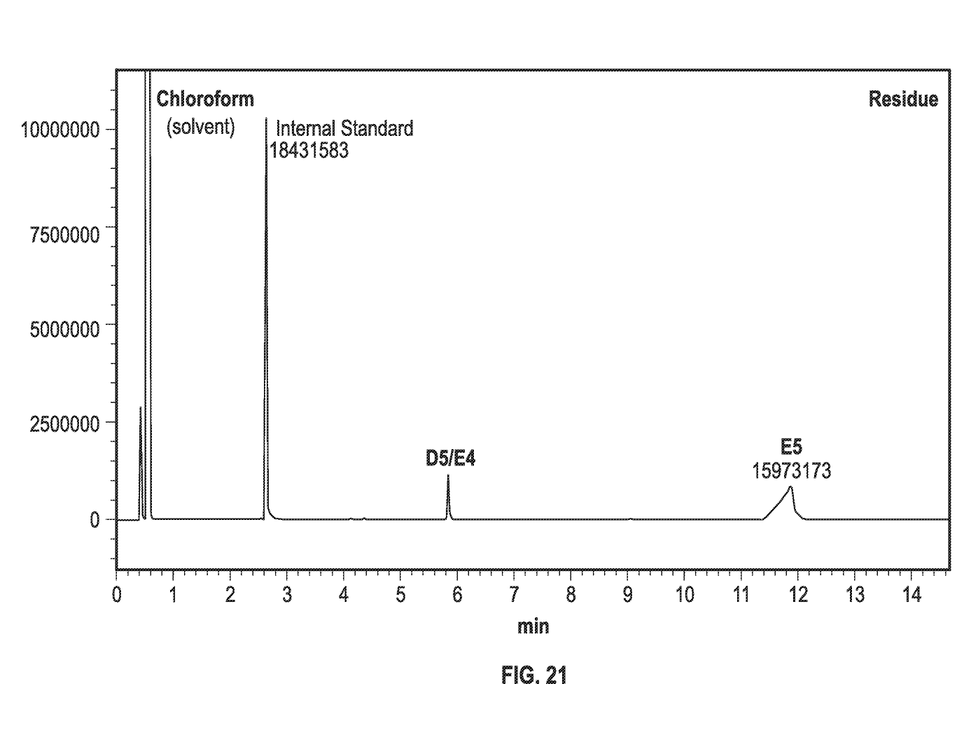

A 41.9 mg-aliquot of the distillation residue was added to a glass vial, followed by addition of dodecane (33.2 mg) and THF (3 mL) as the solvent. The mixture was subjected to gas chromatography using the temperature program described in the General Methods section. From the integration, mass of D4 could be calculated as mₑ=(aₑ×mₛ)/(aₛ×F)=(15973173×33.2 mg)/(18431583×0.857)=33.6 mg. The total mass of D4 in the distillation residue was 33.6 mg×20.3 g÷41.9 mg=16.3 g. The yield of D4 is 16.3 g÷480.85 g mol⁻¹÷40.0 mmol×100%=85%. (FIG. 18. ¹H NMR spectra of the three distillates and the distillation residue resulting from the reactive distillation of an equimolar mixture of esters A1, A2, A4, A5, B1, B2, B4, B5, D1, D2, D4, D5, E1, E2, E4, and E5. (FIG. 19. Gas chromatogram of the second distillate from the reactive distillation of an equimolar mixture of A1, A2, A4, A5, B1, B2, B4, B5, D1, D2, D4, D5, E1, E2, E4, and E5, with internal standard (dodecane) added for calibration. THF was used as the solvent. FIG. 20. Gas chromatogram of the third distillate from the reactive distillation of an equimolar mixture of A1, A2, A4, A5, B1, B2, B4, B5, D1, D2, D4, D5, E1, E2, E4, and E5, with internal standard (dodecane) added for calibration. THF was used as the solvent. FIG. 21. Gas chromatogram of the distillation residue from the reactive distillation of an equimolar mixture of A1, A2, A4, A5, B1, B2, B4, B5, D1, D2, D4, D5, E1, E2, E4, and E5, with internal standard (dodecane) added for calibration. THF was used as the solvent).

Reactive Distillation of a [2×3] Ester Library

Ethyl Acetate (A1), Ethyl Butyrate (B1), and Benzyl Benzoate (C3)

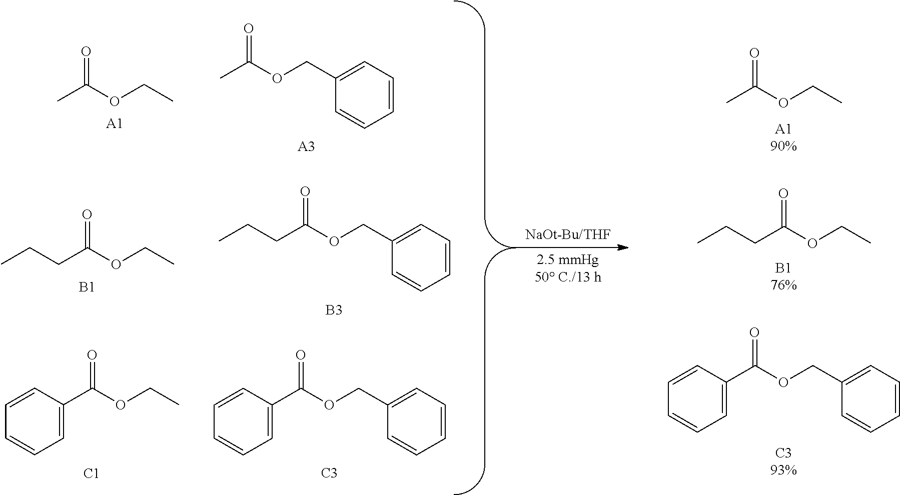

A mixture of A1 (890 mg, 10.0 mmol), B1 (1.17 g, 10.0 mmol), C1 (3.03 g, 20.0 mmol), A3 (1.52 g, 10.0 mmol), B3 (1.80 g, 10.0 mmol), and C3 (2.14 g, 10.0 mmol) was added to a 25 mL two-neck round bottom flask. The reaction flask was equipped with a 185 mm-long Vigreux column cooled by a i-PrOH/CO₂ cold trap (−55 to −50° C.). Short path distillation head was placed on top of the Vigreux column, connecting it to the receiving flask, which was placed in a separate i-PrOH/CO₂ ice bath (−78° C.). A 0.05 mL-aliquot of a 1M sodium tert-butoxide in THF solution was injected into the reaction flask every 30 min for 5 h. Vacuum (2.5 mm Hg) was started at the same time as the first loading of catalyst was added. The first step of the distillation was performed at 50° C. for 5 h, resulting in the first distillate, which was collected as a colorless liquid. ¹H NMR spectroscopy confirmed the identity of this liquid as a mixture of A1 (1.58 g, 17.9 mmol, 90% yield), B1 (106 mg, 0.91 mmol, 5% yield), and THF (solvent, 888 mg, 12.4 mmol). The second distillate was collected after another 8 h of distillation without the Vigreux column. A 0.05 mL-aliquot of a 1M sodium tert-butoxide in THF solution was injected into the reaction flask every 30 min for 8 h. ¹H NMR spectroscopy confirmed the identity of this liquid as a mixture of A1 (35.9 mg, 0.41 mmol, 2% yield), B1 (1.75 g, 15.1 mmol, 76% yield) and THF (solvent, 1.62 g, 22.5 mmol). Esters A3, C1, B3, and C3 were not observed in either of the distillates. The remainder in the distillation flask was identified by ¹H NMR spectroscopy as a mixture of C3 (5.90 g, 27.8 mmol, 93% yield), B3 (209 mg, 1.18 mmol, 6% yield), and C1 (199 mg, 1.33 mmol, 7% yield).

A1: ¹H NMR (CDCl₃): 4.11 (q, ³J=7.1 Hz, 2H), 2.03 (s, 3H), 1.20 (t, ³J=7.1 Hz, 3H) ppm. ¹³C NMR (CDCl₃): 170.8, 60.1, 20.7, 13.9 ppm. Spectral data agree with a previous literature report.⁶ B1: ¹H NMR (CDCl₃): 4.13 (q, ³J=6.8 Hz, 2H), 2.27 (t, ³J=7.4 Hz, 2H), 1.65 (sextet, ³J=7.4 Hz, 2H), 1.26 (t, ³J=6.8 Hz, 3H), 0.96 (t, ³J=7.4 Hz, 3H) ppm. ¹³C NMR (CDCl₃): 173.61, 60.13, 36.32, 18.57, 14.32, 13.70 ppm. Spectral data agree with a previous literature report.^{1 C}3: ¹H NMR (CDCl₃): 8.10 (d, ³J=7.0 Hz, 2H), 7.59 (t, ³J=7.5 Hz, 1H), 7.37-7.50 (m, 7H), 5.40 (s, 2H) ppm. ¹³C NMR (CDCl₃): 166.54, 136.26, 133.21, 130.32, 129.89, 128.78, 128.57, 128.43, 128.36, 66.84 ppm. Spectral data agree with a previous literature report.⁵

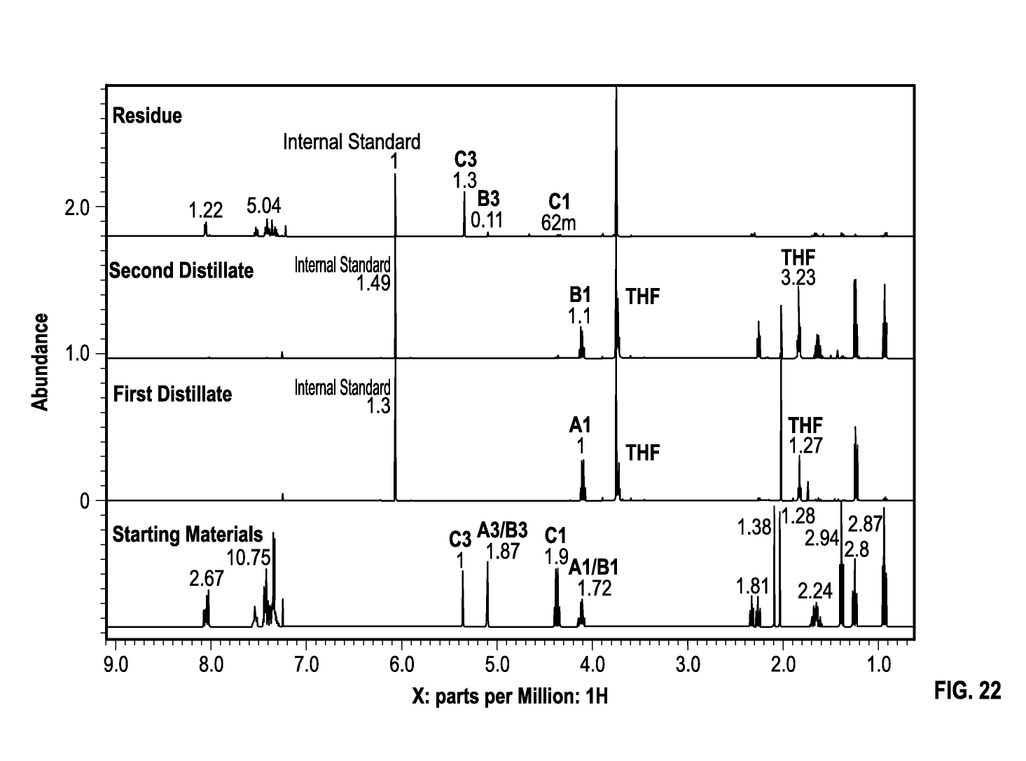

Calculation of the Yields based on the Integration of ¹H NMR Spectra: Internal standard 1,3,5-trimethoxybenzene (673 mg, 3.96 mmol) was added to a 740 mg-aliquot of the first distillate. From their relative integrals in the ¹H NMR spectrum (FIG. 22), the number of moles of A1 was calculated to be 3.96 mmol×1÷(⅔)÷1.34=4.43 mmol. Thus, the total number of moles of A1 in the first distillate was 4.43 mmol×2989 mg÷740 mg=17.9 mmol, corresponding to the yield of A1 of 17.9 mmol÷20.0 mmol×100%=90%. Analogous calculation allowed us to estimate the yields of B1 at 5%.

Similar yield calculation procedure was applied to the second distillate: 1,3,5-trimethoxybenzene (340 mg, 2.00 mmol) was added to a 571 mg-aliquot of the residue. The number of moles of B2 in the aliquot was calculated to be 2.00 mmol×1.1÷(⅔)÷1.49=2.22 mmol. The total number of moles of B2 in the whole of the second distillate was 2.22 mmol×3892 mg÷571 mg=15.1 mmol, corresponding to the yield of 15.1 mmol÷20.0 mmol×100%=76%. Equivalent calculation allowed us to estimate the yields of A1 at 2%.

Analogous yield calculation procedure was applied to the distillation residue as well: 1,3,5-trimethoxybenzene (342 mg, 2.01 mmol) was added to a 969 mg-aliquot of the residue. The number of moles of C3 in the aliquot was calculated to be 2.01 mmol×1.30÷(⅔)=3.93 mmol. The total number of moles of C3 in the whole of the distillation residue was 3.93 mmol×6862 mg÷969 mg=27.8 mmol, corresponding to the yield of 27.8 mmol÷30.0 mmol×100%=93%. Analogous calculation allowed us to estimate the yields of minor fractions B3 and C1 at 6% and 7%, respectively. (FIG. 22. ¹H NMR spectra of the starting mixture (bottom) of esters A1, A3, B1, B3, C1 (2 eq.), and C3, and the two distillates (middle) and distillation residue (top) obtained after the reactive distillation of that mixture).

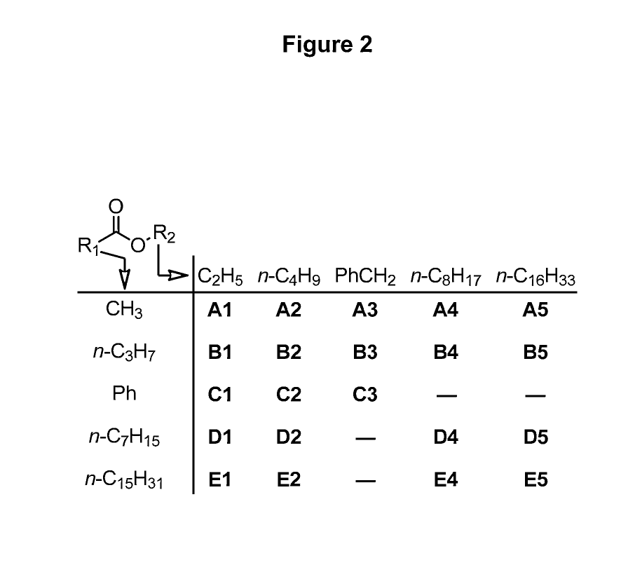

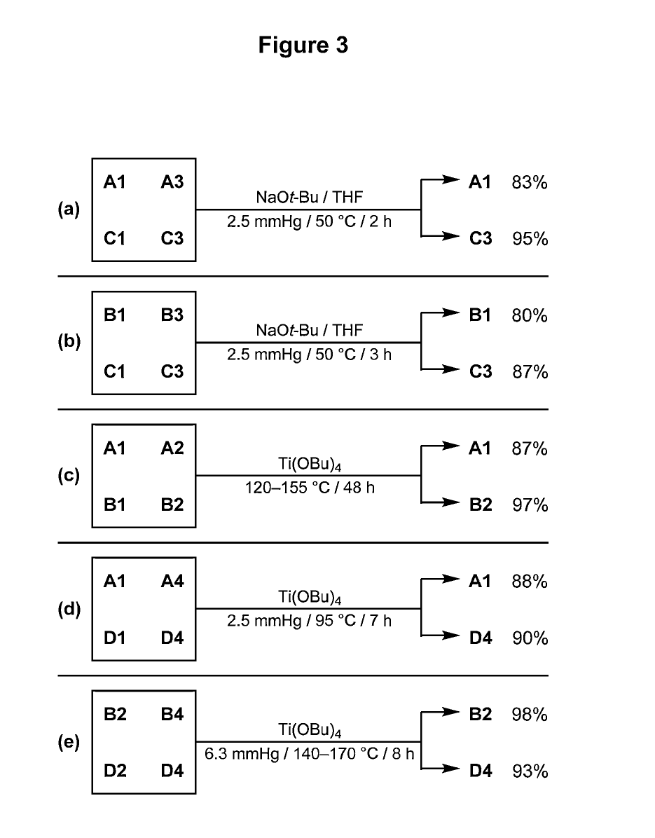

The reactive distillation of mixtures of the 21 esters (A1 through E5) presented in FIG. 2, were performed based on the embodiments herein described. In one embodiment, (as illustrated in FIG. 3) NaOt-Bu was utilized as the acyl exchange catalyst (metal alkoxide) as previously reported by Gagne et al¹⁰ (Stanton, M. G.; Allen, C. B.; Kissling, R. M.; Lincoln, A. L.; Gagné, M. R. J. Am. Chem. Soc. 1998, 120, 5981-5989.). NaOt-Bu was utilized with more volatile species (reactants and products), while Ti(OBu)₄ was found to be more efficient with less volatile species (reactants and products). An equimolar mixture¹¹ of ethyl acetate (A1), benzyl acetate (A3), ethyl benzoate (C1), and benzyl benzoate (C3) was exposed to a catalytic amount of a 1M solution of NaOt-Bu in tetrahydrofuran (THF) and then subjected to distillation in vacuo (2.50 mmHg) at 50° C. After 2 h, the distillate was found to be pure Al, which was formed in 83% yield as quantified by ¹H nuclear magnetic resonance (NMR) spectroscopy. The distillation residue contained ester C3 in 95% yield, and only traces of the crossover esters A3 (5%) and C1 (4%).

Similarly in FIG. 3(b) Ethyl butyrate (B1), butyl butyrate (B2), Cl and C3, formed the reactive mixture. On distillation, B1 proved to be the most volatile species, forming 80% of the distillate, whilst C3 was the least volatile ester, being present in the residual at 87%.

In another embodiment (FIG. 3(c)), Ti(OBu)₄¹² was employed as the catalyst for the reactive distillation of the species A1, A2, B1, and B2. The distillation was performed at temperatures between about 120 to about 150° C., under atmospheric pressure, wherein A1 was recovered at 84% yield (most volatile), and B2 at 98% yield (least volatile). FIG. 3(d) and FIG. 3(e) are two further embodiments of the reactive distillation described herein, and also are examples of successful sorting of 2×2 ester libraries.

Separation of esters by reactive distillation from a 3×3 ester mixture

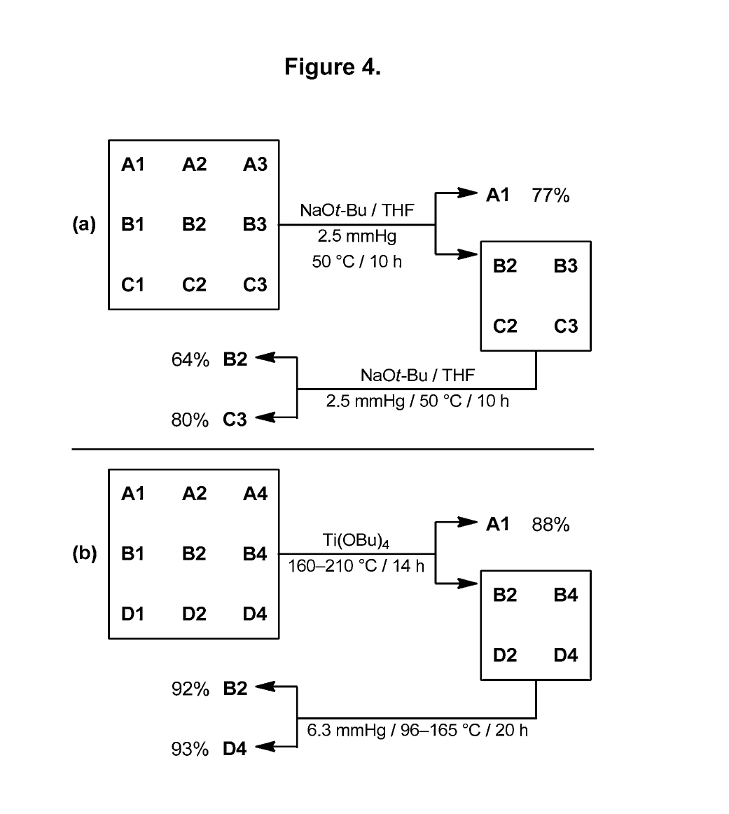

A vacuum distillation of A1-C3 was performed in accordance with an embodiment of the method of separation herein described, wherein the distillation employed NaOt-Bu as the catalyst (FIG. 4 (a)). Ethyl acetate (A1) was isolated as the first reactive distillate (first distillation fraction: 77% w/w yield); B2 as the second distillation fraction (64% w/w yield) produced by continued distillation in the same apparatus, leaving C3 as the distillation residual (in 80% w/w yield). In a further embodiment (FIG. 4B), Ti(OBu)₄ was employed as the catalyst for the 3×3 self-sorting of a less volatile group of esters (A1, A2, A4, B1, B2, B4, D1, D2, and D4), wherein Al comprised the first distillation fraction (88% w/w yield); B2 comprised the second distillation (volatile) fraction (92% w/w yield), and D4 comprised the non-volatile distillation residue (93% w/w yield).

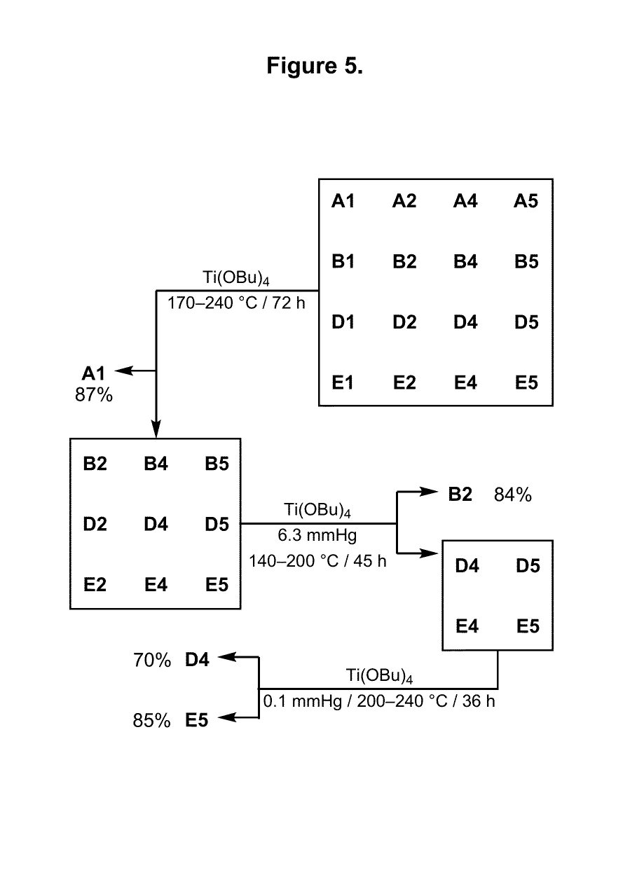

In another embodiment of the method herein described, separation of esters by reactive distillation from a 4×4 ester library (mixture) is illustrated (see FIG. 5); under atmospheric pressure (for 72 hrs.) and using the previously described titanium catalyst. A1 comprises the first distillation fraction with an 87% w/w yield. The removal of A1 effectively exhausts the mixture of the reactive components required to form A2; A4; A5; B1, D1, and E1, hence removing the likelihood of their presence in further fractions. The second stage of the reaction thus occurs under mild vacuum (6.3 mmHg for 45 hrs. with additional catalyst) to yield a second fraction comprising of B2 (in 81% w/w yield); the third stage of the reaction occurs in vacuo (0.1 mmHg) with additional catalyst, producing D4 (72% w/w yield) as the third fractional distillate, and E5 (90% w/w yield) as the distillation residue.

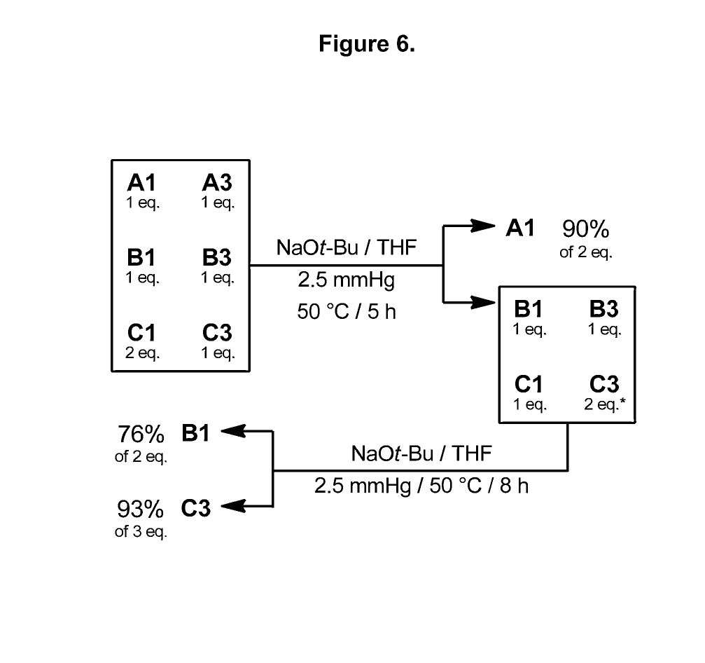

In a further embodiment, reactive distillation is applied to a non-equimolar [2×3] ester mixture, hence an example of the applicability of self-sorting distillative protocols that is not limited to [n×n] mixtures, nor to equimolar component compositions. FIG. 6 is an illustration of such an embodiment, in which one species (C1) was added in two-fold excess relative to all other ester species (which were otherwise equimolar). Upon distillation, A1 is formed as the first product, wherein its isolated amount is about twice the molar amount of A1 originally added to the mixture. The second equivalent of A1 comes from the extraction of all acetate (1 equivalent from A3); and from the equimolar amount of ethyl esters (1 equivalent from either B1 or C1). Once the distillation of A1 is complete, the next most volatile fraction is B2, which extracts the remaining ethyl esters (1 equivalent from C1) and butanoates (1 equivalent from B3). Left over are about 3 equivalents of C3, which are commensurate to the original amounts of benzoate (2 equivalents in C1 and 1 equivalent in C3), and benzyl esters (1 equivalent each in A3, B3, and C3) in the starting library.

Esters are volatile and pleasantly smelling compounds, commonly used as food additives. Using Ti(OBu)₄-catalyzed acyl exchange as described herein a scent transmutation can occur whereby two fragrant esters swap their acyl and alkoxy substituents, and are (during the course of a reactive distillation) quantitatively converted into two different esters with distinct fragrance properties.

As described above (FIG. 1), given four esters constructed by random transesterification of an equimolar mixture of two carboxylic acids and two alcohols, and exposing said mixture to titanium(IV) butoxide catalyst, an acyl exchange occurs which is the swapping of acyl and alkoxy substituents between the esters. Since the acyl exchange reaction is reversible, four esters will freely transfer material amongst themselves, and a dynamic equilibrium will eventually be established. Such an equilibrating collection of esters is as previously described a dynamic combinatorial library (DCL). Again, through the reversible acyl exchange, the DCL is capable of adapting to external stimuli by changing its composition. Subjecting a DCL to distillation either at atmospheric or lowered pressure removes the most volatile ester (depicted in FIG. 1 as the red-red combination), formed from the alcohol and the carboxylic acid of lower molecular masses. As this volatile ester is removed, the remainder of the mixture re-equilibrates to produce more of it, and this process continues until essentially all of the volatile alkoxy and the volatile acyl groups are removed as the distillate. At the same time, the distillation residue is vastly enriched in the least volatile compound (blue-blue combination), at the expense of the two esters of intermediate volatility. In essence, the most and the least volatile esters are amplified, while the crossover esters of moderate volatility are sacrificed. In some embodiments this process can be iteratively repeated in complex libraries; such as in one embodiment where sixteen member library can be reduced in complexity to just four final products during the course of a reactive distillation. In another embodiment utilizing a related dynamic imine libraries 25 imine constituents may be reduced to five final products. In a further embodiment of the method of separating esters, if the distillation does not start with a four ester mixture, but instead uses the two “wrong” esters (that is, the two crossover red-blue combinations from FIG. 1, which have intermediate volatility) two moderate-volatility esters quantitatively give rise to two different compounds that is a highly volatile and a nonvolatile ester, and the high yields of this reaction are driven by fractional vacuum distillation.

As many esters are pleasantly smelling (and essentially nontoxic) compounds and some are even approved as food additives by the US Food and Drug Administration (FDA), an ester transmutation experiment as described herein may also proceed with a change in odors from the starting mixture of two esters to the two final products, thereby allowing the change in the chemical composition to detected by smell during the course of the reaction. In one such embodiment described herein Ti(OBu)₄-catalyzed transesterification was used in the synthesis of two ester products with different organoleptic properties from the two starting esters, wherein the yields of the resulting products can be quantified by nuclear magnetic resonance (NMR) spectroscopy and gas chromatography (GC).

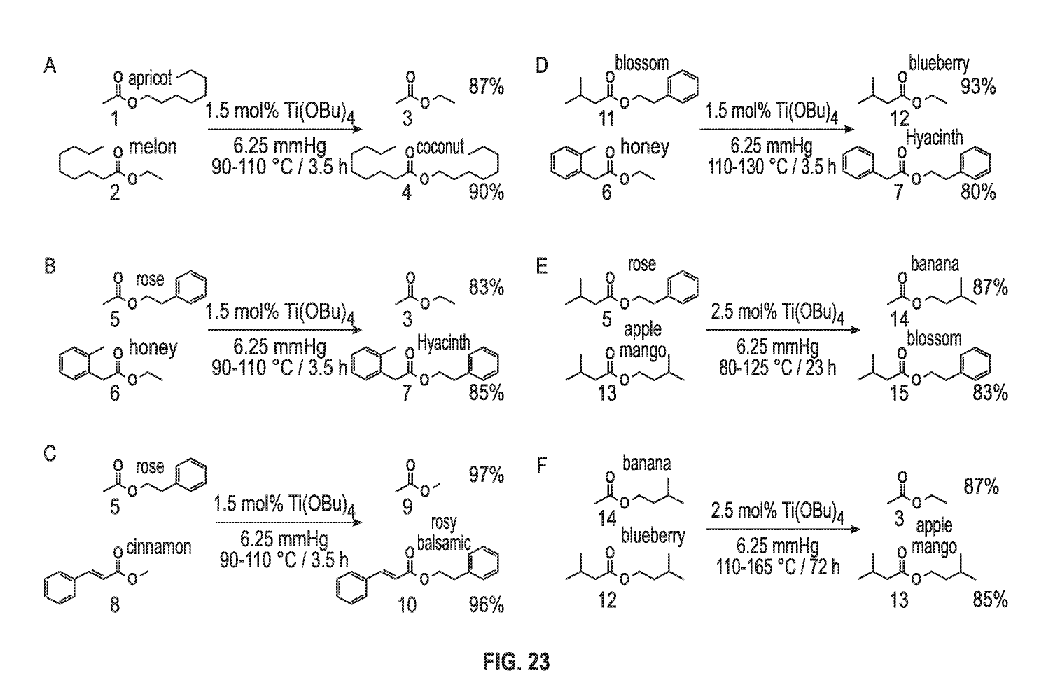

In embodiments herein described, six scent transmutation experiments were performed as shown in FIG. 23. All of them employ commercially available and FDA-approved ester starting materials. The first five experiments (FIG. 23 (A-E)) were performed under a reduced pressure, which can be achieved using a small vacuum pump—such as those used for rotary evaporators. The last experiment (FIG. 23 (F)) utilized atmospheric pressure, but this distillation took significantly longer to complete.

In one embodiment (FIG. 23 (A)) two starting esters: octyl acetate (1) and ethyl octanoate (2), with distinct aromas of apricot and melon, respectively were employed. Equimolar amounts of these two esters were placed into a round-bottom distillation flask and exposed to 1.5 molar % of Ti(OBu)₄ as the catalyst. The mixture was placed under vacuum and heating commenced. It was found that in this embodiment the progress of reactive distillation could be followed by monitoring the temperature of the external heating oil bath, rather than the temperature of the vapors (as would be the case in a standard distillation). When the oil bath temperature is kept between 90 and 110° C., only ethyl acetate (3) distills out of the reaction mixture. After the distillation of this material was complete (in approx. 3.5 h), the heating was stopped and the distillation setup was disassembled. Octyl octanoate (4) was the dominant component of the distillation residue. The two product compounds could be qualitatively identified by their smell. Ethyl acetate had an aroma of pineapple or pears. Octyl octanoate (4) in contrast has a heavy odor of coconut and is clearly distinct from the two starting materials. Following the qualitative identification of distillation products, their yields were quantified by a combination of NMR spectroscopy and GC. The embodiments described above, provide a method that may be applied industrially, wherein a single reaction setup, and distillation are the only requirements for the separation of multiple reactive species in high yields and high purity, and thus expanding the experimental domain of “parallel synthesis”, wherein complex mixtures of precursors are used to expediently synthesize multiple pure chemicals as compared to methods known in the art that entails mixing two- and only two known compounds in the absence of any potentially competitive reactants, therefore such methods as described herein are both cheap and time efficient as compared to such known methods. While exemplary embodiments have been shown and described, modifications thereof can be made by one skilled in the art without departing from the scope or teachings herein. The embodiments describe herein are exemplary only and are not limiting. Many variations and modifications of the systems, apparatus, and processes described herein are possible and are within the scope of the invention as claimed below, (see further: Scent Transmutation: A New Way to Teach on Chemical Equilibrium, Distillation, and Dynamic Combinatorial Chemistry”, Journal of Chemical Education, year 2014, volume 91, issue 6, pp. 830-833; and “Distillative Self-Sorting of Dynamic Ester Libraries”, Journal of Organic Chemistry, year 2013, volume 78, issue 24, pp. 12710-12716. Authors: Qing Ji and Ognjen S. Miljanic, incorporated herein by reference in their entirety). Accordingly, the scope of protection is not limited to the embodiments described herein, but is only limited by the claims that follow, the scope of which shall include all equivalents of the subject matter of the claims.

The references cited below are incorporated herein in their entirety: (1) Tasic, L.; Abraham, R. J.; Rittner, R. Magn. Reson. Chem. 2002, 40, 449-454; (2) Liu, X.; Wu, J.; Shang, Z. Synth. Commun. 2012, 42, 75-83; (3) Salome, C.; Kohn, H. Tetrahedron 2009, 65, 456-460; (4) Poeylaut-Palena, A. A.; Testero, S. A.; Mata, E. G. Chem. Commun. 2011, 47, 1565-1567; (5) Cronin, L.; Manoni, F.; O'Connor, C. J.; Connon, S. J. Angew. Chem. Int. Ed. 2010, 49, 3045-3048; (6) Das, A.; Chaudhuri, R.; Liu, R. S. Chem. Commun. 2009, 27, 4046-4048; (7) Gowrisankar, S.; Neumann, H.; Beller, M. Angew. Chem. Int. Ed. 2011, 50, 5139-5143; (8) Mantri, K.; Komura, K.; Sugi, Y. Synthesis 2005, 12, 1939-1944; (9) Harmsen, G. J. Chem. Eng. Process. 2007, 46, 774-780. (10) Reactive Distillation: Status and Future Directions; Sundmacher, K., Kienle, A., Eds.; Wiley-VCH: Weinheim, 2003. For methyl acetate, see: (11) Agreda, V. H.; Partin, L. R. U.S. Pat. No. 4,435,595, 1984. (12) Popken, T.; Steinigeweg, S.; Gmehling, J. Ind. Eng. Chem. Res. 2001, 40, 1566-1574. For butyl acetate, see: (13) Hanika, J.; Kolena, J.; Smejkal, Q. Chem. Eng. Sci. 1999, 54, 5205-5209. (14) Zhicai, Y.; Xianbao, C.; Jing, G. Chem. Eng. Sci. 1998, 53, 2081-2088. (15) Kiss, A. A. Fuel Process. Technol. 2011, 92, 1288-1296. (16) Dimian, A. C.; Bildea, C. S.; Omota, F.; Kiss, A. A. Comput. Chem. Eng. 2009, 33, 743-750. (17) Omota, F.; Dimian, A. C.; Bliek, A. Chem. Eng. Sci. 2003, 58, 3159-3174. (18) Dynamic Combinatorial Chemistry; Reek, J. N. H., Otto, S., Eds.; Wiley-VCH: Weinheim, 2010. (19) Corbett, P. T.; Leclaire, J.; Vial, L.; West, K. R.; Wietor, J.-L.; Sanders, J. K. M; Otto, S. Chem. Rev. 2006, 106, 3652-3711. (20) Rowan, S. J.; Cantrill, S. J.; Cousins, G. R. L.; Sanders, J. K. M.; Stoddart, J. F. Angew. Chem. Int. Ed. 2002, 41, 898-952. (d) Ludlow, R. F.; Otto, S. Chem. Soc. Rev. 2008, 37, 101-108. (21) Osowska, K.; Miljanić, O. \check{S}. J. Am. Chem. Soc. 2011, 133, 724-726. (22) Lirag, R. C.; Osowska, K.; Miljanić, O. \check{S}. Org. Biomol. Chem. 2012, 10, 4847-4850. (23) Osowska, K.; Miljanić, O. \check{S}. Angew. Chem. Int. Ed. 2011, 50, 8345-8349. (24) Safont-Sempere, M. M.; Fernandez, G.; Würthner, F. Chem. Rev. 2011, 111, 5784-5814. (b) Osowska, K.; Miljanić, O. \check{S}. Synlett 2011, 1643-1648. (25) Ghosh, S.; Isaacs, L.; In Dynamic Combinatorial Chemistry in Drug Discovery, Bioorganic Chemistry, and Materials Science; Miller, B. L., Ed.; Wiley: Hoboken, N.J., 2010; pp 155-168. (26) Northrop, B. H.; Zheng, Y.-R.; Chi, K.-W.; Stang, P. J. Acc. Chem. Res. 2009, 42, 1554-1563. (27) Nitschke, J. R. Acc. Chem. Res. 2007, 40, 103-112. (28) For previous DCLs constructed from ester-based components, see: (29) Kaiser, G.; Sanders, J. K. M. Chem. Commun. 2000, 1763-1764. (30) Rowan, S. J.; Reynolds, D. J.; Sanders, J. K. M. J. Org. Chem. 1999, 64, 5804-5814. (31) Amatore, C.; Jutand, A.; Meyer, G.; Mottier, L. Chem. Eur. J. 1999, 5, 466-473. (32) Rowan, S. J.; Hamilton, D. G.; Brady, P. A.; Sanders, J. K. M. J. Am. Chem. Soc. 1997, 119, 2578-2579. (33) Brady, P. A.; Sanders, J. K. M. J. Chem. Soc., Perkin Trans. 1 1997, 3237-3253. (34) Rowan, S. J.; Brady, P. A.; Sanders, J. K. M. Angew. Chem., Int. Ed. Engl. 1996, 35, 2143-2145. (35) Brady, P. A.; Bonar-Law, R. P.; Rowan, S. J.; Suckling, C. J.; Sanders, J. K. M. Chem. Commun. 1996, 319-320. (36) Herrmann, A. Chem. Eur. J. 2012, 18, 8568-8577. (37) Buchs, B.; Fieber, W.; Vigouroux-Elie, F.; Sreenivasachary, N.; Lehn, J.-M.; Herrmann, A. Org. Biomol. Chem. 2011, 9, 2906-2919. (38) Buchs, B.; Godin, G.; Trachsel, A.; de Saint Laumer, J.-Y.; Lehn, J.-M.; Herrmann, A. Eur. J. Org. Chem. 2011, 681-695. (39) Kissling, R. M.; Gagné, M. R. Org. Lett. 2000, 2, 4209-4212. (40) Stanton, M. G.; Allen, C. B.; Kissling, R. M.; Lincoln, A. L.; Gagné, M. R. J. Am. Chem. Soc. 1998, 120, 5981-5989. Schnurrenberger, P.; Züger, M. F.; Seebach, D. Helv. Chim. Acta 1982, 65, 1197-1201. (41) Curtin, D. Y. Rec. Chem. Prog. 1954, 15, 111-128. (b) Seeman, J. I. Chem. Rev. 1983, 83, 83-134.

What is claimed is:

1. A method of separating a mixture of compounds, the method comprising:
reactively distilling said mixture of compounds in the presence of a catalyst, wherein said distilling forms:
a) at least a first distillation fraction; and
b) a distillation residue;
wherein said first fraction comprises a first volatile product that is at least 70% (w/w), and wherein said residue comprises a non-volatile product that is at least 70% (w/w).

2. The method of claim 1, wherein said mixture is comprised of greater than two compounds.

3. The method of claim 1, wherein said compounds comprise a dynamic combinatorial library.

4. The method of claim 1, wherein said catalyst is a metal alkoxide.

5. The method of claim 4, wherein said catalyst is Ti(OBu)₄

6. The method of claim 4, wherein said catalyst is NaOt-Bu

7. The method of claim 1, wherein said compounds are selected from esters, ethers, alkylated aromatics, alkenes, alkynes, thiols, disulfides, acetals, hydrazones, and oximes.

8. The method of claim 1, wherein said first volatile product comprises the lowest boiling point of said compounds.

9. The method of claim 1, wherein said non-volatile product comprises the highest boiling point of said compounds.

10. The method of claim 1, wherein said distilling forms a second distillation fraction.

11. The method of claim 10, wherein said second distillation fraction comprises a second volatile product.

12. The method of claim 11, wherein said second volatile product is about 70% (w/w).

13. The method of claim 1, wherein said distilling forms a third distillation fraction.

14. The method of claim 13, wherein said third distillation fraction comprises a third volatile product.

15. The method of claim 14, wherein said third volatile product is about 70% (w/w).

16. The method of claim 1, wherein said mixtures of compounds comprise hydrolyzed lignin; natural oils; naturally derived fragrant esters; synthetically derived fragrant esters; or natural fats.

17. The method of claim 16, wherein said the distillation residue comprises biomass-derived fuels.

18. The method of claim 16, wherein said the non-volatile product comprises biomass-derived fuels.

19. The method of claim 17, wherein said fuel is biodiesel or biobutanol.

20. A method of separating a mixture of N² esters, the method comprising:
reactively distilling said mixture of esters in the presence of a metal alkoxide, wherein said distilling forms:
a) at least a first distillation fraction; and
b) a distillation residue;
wherein said mixture is reduced to N fractions of discrete esters of at least 70% w/w yield.
